(19) United States
(12) Patent Application Publication
(10) Pub. No.: US 2026/0222949 A1
(43) Pub. Date: Jul. 30, 2026

(54) METHODS PERFORMED BY NODES IN WIRELESS COMMUNICATION SYSTEM AND THE NODES

(71) Applicant: Samsung Electronics Co., Ltd., Suwon-si (KR)

(72) Inventors: Fuyuan LI, Beijing (CN); Weiwei WANG, Beijing (CN); Hong WANG, Beijing (CN); Lixiang XU, Beijing (CN)

(21) Appl. No.: 19/446,150

(22) Filed: Jan. 12, 2026

(30) Foreign Application Priority Data
Jan. 24, 2025 (CN) 202510123375.5

(51) Int. Cl. H04W 36/08; H04W 36/00; H04W 36/04

(52) U.S. Cl. CPC H04W 36/08; H04W 36/008355; H04W 36/04

(57) ABSTRACT

The disclosure relates to a 5G or 6G communication system for supporting a higher data transmission rate. A method performed by a first node in a wireless communication system is provided. The method includes receiving, from a third node, a handover request message; and transmitting, to a second node, a first secondary node (SN) addition request message including information for identifying that the first SN addition request message and a second SN addition request message are related to a same user equipment (UE), wherein the second SN addition request message is associated with a fourth node.

### CROSS-REFERENCE TO RELATED APPLICATION(S)

This application is based on and claims priority under 35 U.S.C. § 119(a) of a Chinese patent application number 202510123375.5, filed on Jan. 24, 2025, in the Chinese Intellectual Property Office, the disclosure of which is incorporated by reference herein in its entirety.

### BACKGROUND

### 1. Field

The disclosure relates to a field of wireless communication technology. More particularly, the disclosure relates to a method performed by a node in a wireless communication system and the respective node.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Aspects of the disclosure are to address at least the above-mentioned problems and/or disadvantages and to provide at least the advantages described below. Accordingly, an aspect of the disclosure is to provide a field of wireless communication technology.

Additional aspects will be set forth in part in the description which follows and, in part, will be apparent from the description, or may be learned by practice of the presented embodiments.

In accordance with an aspect of the disclosure, a method performed by a first node in a wireless communication system is provided. The method includes receiving, from a third node, a handover request message, and transmitting, to a second node, a first secondary node (SN) addition request message including information for identifying that the first SN addition request message and a second SN addition request message are related to a same user equipment (UE), wherein the second SN addition request message is associated with a fourth node.

In accordance with another aspect of the disclosure, a method performed by a second node in a wireless communication system is provided. The method includes receiving, from a first node, a first secondary node (SN) addition request message including information for identifying that the first SN addition request message and a second SN addition request message are related to a same user equipment (UE), and identifying, based on the information, that the first SN addition request message and the second SN addition request message are related to the same UE, wherein the second SN addition request message is received from a fourth node.

In accordance with another aspect of the disclosure, a first node in a wireless communication system is provided. The first node includes at least one transceiver, at least one processor communicatively coupled to the at least one transceiver, and at least one memory, communicatively coupled to the at least one processor, storing instructions executable by the at least one processor individually or in any combination to cause the first node to receive, from a third node, a handover request message, and transmit, to a second node, a first secondary node (SN) addition request message including information for identifying that the first SN addition request message and a second SN addition request message are related to a same user equipment (UE), wherein the second SN addition request message is associated with a fourth node.

In accordance with another aspect of the disclosure, a second node in a wireless communication system is provided. The second node includes at least one transceiver, at least one processor communicatively coupled to the at least one transceiver, and at least one memory, communicatively coupled to the at least one processor, storing instructions executable by the at least one processor individually or in any combination to cause the second node to receive, from a first node, a first secondary node (SN) addition request message including information for identifying that the first SN addition request message and a second SN addition request message are related to a same user equipment (UE), and identify, based on the information, that the first SN addition request message and the second SN addition request message are related to the same UE, wherein the second SN addition request message is received from a fourth node.

In accordance with another aspect of the disclosure, a method performed by a second node in a wireless communication system is provided. The method includes transmitting a second handover request to a fourth node, receiving a second handover response from the fourth node, the second handover response comprising context reference information of a user equipment at a third node, wherein the context reference information of the user equipment at the third node comprises an identifier of the third node and an identifier assigned by the third node to the user equipment, wherein the third node is a secondary node of the fourth node, and transmitting a first handover request to a first node, the first handover request comprising the context reference information of the user equipment at the third node, wherein the first node is a candidate node of the second node.

According to an embodiment, the user equipment switches from accessing to the second node to accessing to the fourth node, a first message is transmitted by the fourth node to the first node, and the first message includes at least one of information for requesting a direct forwarding path, information for requesting a data forwarding address, and an identifier assigned by the second node to the user equipment. A second message is transmitted by the first node to the fourth node, and the second message includes at least one of first information related to the direct forwarding path, first address information related to the data forwarding address, and an identifier assigned by the first node to the user equipment.

According to an embodiment, the information for requesting the direct forwarding path includes at least one of an identifier of the fourth node and the identifier of the third node.

According to an embodiment, the first information includes information on whether there is a direct forwarding path between the first node and the third node based on a packet data unit session.

According to an embodiment, the first address information includes at least one of a packet data unit session or data radio bearer-based data forwarding address between the first node and the third node, a packet data unit session or data radio bearer-based data forwarding address between a fifth node and the fourth node, and a packet data unit session or data radio bearer-based data forwarding address between the fifth node and the third node, wherein the fifth node is a secondary node of the first node.

According to an embodiment, the first message further includes notification information for releasing a resource of a candidate cell on the fourth node, and the notification information may comprise identifier information of a to-be-released candidate cell on the fourth node.

According to an embodiment, access layer security information of a candidate cell on the first node is received by the first node from the fourth node, wherein the access layer security information is received through a Layer 1 or Layer 2 Triggered Mobility (LTM) Configuration Update message, or received through a Cell Switch Notification message.

According to an embodiment, the access layer security information of the candidate cell on the first node includes at least one of an identifier of the candidate cell on the first node, an LTM configuration identifier, a key of the candidate cell, and a next hop chaining counter.

According to an embodiment, the first message further includes at least one of a globally unique access and mobility management function (AMF) identifier, a user equipment next generation (NG) application protocol identifier assigned by an access and mobility management function (AMF) network element, and downlink or uplink tunnel information of each packet data unit session resource.

According to an embodiment, the second message further includes information for releasing a resource of a candidate cell on the first node.

According to an embodiment, a third message is transmitted by the first node to the fifth node, the third message includes at least one of information for requesting a direct forwarding path and information for requesting a data forwarding address, and the fifth node is a secondary node of the first node. A fourth message is transmitted by the fifth node to the first node, and the fourth message includes at least one of second information related to the direct forwarding path and second address information related to the data forwarding address.

According to an embodiment, the second information includes at least one of information on whether there is a direct forwarding path between the fifth node and the fourth node, and information on whether there is a direct forwarding path between the fifth node and the third node.

According to an embodiment, the second address information includes at least one of the packet data unit session or data radio bearer-based data forwarding address between the fifth node and the fourth node, and the packet data unit session or data radio bearer-based data forwarding address between the fifth node and the third node.

According to an embodiment, the third message further includes information related to access layer security information of a candidate cell on the fifth node, wherein the information related to the access layer security information of the candidate cell on the fifth node is determined according to security information related to the access layer security information of the candidate cell on the first node, and the fifth node is the secondary node of the first node.

According to an embodiment, the first message is an LTM Configuration Update message and a Cell Switch Notification message, and the second message may be an LTM Configuration Update Acknowledge message.

According to an embodiment, the method further includes receiving a first handover response from the first node. The first handover response includes information related to the addition of the third node as the secondary node.

According to an embodiment, the second handover response further includes resource configuration information of the user equipment at a candidate cell on the third node.

According to another aspect of the disclosure, a method performed by a first node in a wireless communication system is provided. The method includes receiving a first handover request from a second node, the first handover request comprising context reference information of a user equipment at a third node, wherein a second handover request is transmitted by the second node, a second handover response is transmitted by a fourth node, and the second handover response includes the context reference information of the user equipment at the third node, and transmitting a first addition request to the third node according to the context reference information of the user equipment at the third node, the first addition request comprising a request for an addition of the third node as a secondary node to establish dual connectivity for the user equipment. Here, the first node is a candidate node of the second node, the context reference information of the user equipment at the third node includes an identifier of the third node and an identifier assigned by the third node to the user equipment, and the third node is a secondary node of the fourth node.

According to an embodiment, the method further includes receiving a first addition response from the third node, the first addition response comprising information related to an acknowledgement of the third node as the secondary node to establish dual connectivity for the user equipment, and transmitting a first handover response to the second node, the first handover response comprising information related to the addition of the third node as the secondary node.

According to an embodiment, the first addition request further includes first identifier information of the user equipment, the first addition response further includes resource configuration information of the user equipment at a candidate cell on the third node, and the first handover response further includes the resource configuration information of the user equipment at the candidate cell on the third node.

According to an embodiment, the first handover request further includes at least one of an identifier of the fourth node and an identifier assigned by the fourth node to the user equipment. Here, the first identifier information includes at least one of an identifier of the second node, an identifier assigned by the second node to the user equipment, the identifier of the third node, the identifier assigned by the third node to the user equipment, the identifier of the fourth node, and the identifier assigned by the fourth node to the user equipment.

According to an embodiment, the user equipment switches from accessing to the second node to accessing to the fourth node. The method further includes receiving a first message from the fourth node. The first message includes at least one of information for requesting a direct forwarding path, information for requesting a data forwarding address, and the identifier assigned by the second node to the user equipment. The method further includes transmitting a second message to the fourth node. The second message includes at least one of first information related to the direct forwarding path, first address information related to the data forwarding address, and an identifier assigned by the first node to the user equipment.

According to an embodiment, the information for requesting the direct forwarding path includes at least one of the identifier of the fourth node and the identifier of the third node.

According to an embodiment, the first information includes information on whether there is a direct forwarding path between the first node and the third node based on a packet data unit session.

According to an embodiment, the first address information includes at least one of a packet data unit session or data radio bearer-based data forwarding address between the first node and the third node, a packet data unit session or data radio bearer-based data forwarding address between a fifth node and the fourth node, and a packet data unit session or data radio bearer-based data forwarding address between the fifth node and the third node. Here, the fifth node is a secondary node of the first node.

According to an embodiment, the first message further context reference information of the user equipment at the second node. The method further includes performing context association on the user equipment according to the context reference information of the user equipment at the second node.

According to an embodiment, the first message further includes notification information for releasing a resource of a candidate cell on the fourth node, and the notification information includes identifier information of a to-be-released candidate cell on the fourth node. The method further includes releasing the resource of the candidate cell identified by the identifier information in the notification information.

According to an embodiment, the method further includes receiving access layer security information of a candidate cell on the first node from the fourth node. Here, the access layer security information is received through a Layer 1 or Layer 2 Triggered Mobility (LTM) Configuration Update message, or received through a Cell Switch Notification message.

According to an embodiment, the method further includes determining information related to access layer security information of a candidate cell on the fifth node, according to security information related to the access layer security information of the candidate cell on the first node. The fifth node is the secondary node of the first node.

According to an embodiment, the access layer security information of the candidate cell on the first node includes at least one of an identifier of the candidate cell on the first node, an LTM configuration identifier, a key of the candidate cell, and a next hop chaining counter.

According to an embodiment, the first message further includes at least one of a globally unique access and mobility management function (AMF) identifier, a user equipment next generation (NG) application layer protocol identifier assigned by an access and mobility management function (AMF) network element, and downlink or uplink tunnel information of each packet data unit session resource.

According to an embodiment, the second message further includes notification information for releasing a resource of a candidate cell on the first node.

According to an embodiment, the method further includes transmitting a third message to the fifth node. The third message includes at least one of information for requesting a direct forwarding path, and information for requesting a data forwarding address. The method further includes receiving a fourth message from the fifth node. The fourth message includes at least one of second information related to the direct forwarding path, and second address information related to the data forwarding address.

According to an embodiment, the second information includes at least one of information on whether there is a direct forwarding path between the fifth node and the fourth node, and information on whether there is a direct forwarding path between the fifth node and the third node.

According to an embodiment, the second address information includes at least one of the packet data unit session or data radio bearer-based data forwarding address between the fifth node and the fourth node, and the packet data unit session or data radio bearer-based data forwarding address between the fifth node and the third node.

According to an embodiment, the third message may further comprise the information related to the access layer security information of the candidate cell on the fifth node.

According to an embodiment, the first message is an LTM Configuration Update message and a Cell Switch Notification message, and the second message is an LTM Configuration Update Acknowledge message.

According to another aspect of the disclosure, a method performed by a third node in a wireless communication system is provided. The method includes receiving a first addition request from a first node, the first addition request being used to request an addition of the third node as a secondary node to establish dual connectivity for the user equipment, transmitting a first addition response to the first node, the first addition response comprising information related to an acknowledgement of the third node as the secondary node to establish the dual connectivity for the user equipment. A second handover request is transmitted by a second node, a second handover response is transmitted by a fourth node, and the second handover response comprises context reference information of a user equipment at the third node. Here, the first node is a candidate node of the second node, and the third node is a secondary node of the fourth node. The context reference information of the user equipment at the third node comprises an identifier of the third node and an identifier assigned by the third node to the user equipment.

According to an embodiment, the first addition request includes first identifier information of the user equipment. The method further includes determining resource configuration information of the user equipment at a candidate cell on the third node according to the first identifier information and a first rule. The first rule includes configuring identical resources for the same user equipment at the same candidate cell. The first addition response further includes the resource configuration information of the user equipment at the candidate cell on the third node.

According to an embodiment, the user equipment switches from accessing to the second node to accessing to the fourth node. A first message is transmitted by the fourth node to the first node, and the first message comprises at least one of information for requesting a direct forwarding path, information for requesting a data forwarding address, and an identifier assigned by the second node to the user equipment. A second message is transmitted by the first node to the fourth node, and the second message includes at least one of first information related to the direct forwarding path, first address information related to the data forwarding address, and an identifier assigned by the first node to the user equipment.

According to an embodiment, the information for requesting the direct forwarding path includes at least one of an identifier of the fourth node and the identifier of the third node.

According to an embodiment, the first information includes information on whether there is a direct forwarding path between the first node and the third node based on a packet data unit session.

According to an embodiment, the first address information includes at least one of a packet data unit session or data radio bearer-based data forwarding address between the first node and the third node, a packet data unit session or data radio bearer-based data forwarding address between a fifth node and the fourth node, and a packet data unit session or data radio bearer-based data forwarding address between the fifth node and the third node. Here, the fifth node is a secondary node of the first node.

According to an embodiment, the first message further includes notification information for releasing a resource of a candidate cell on the fourth node, and the notification information comprises identifier information of a to-be-released candidate cell on the fourth node.

According to an embodiment, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message

According to an embodiment, the access layer security information of the candidate cell on the first node includes at least one of an identifier of the candidate cell on the first node, an LTM configuration identifier, a key of the candidate cell, and a next hop chaining counter.

According to an embodiment, the first message further includes at least one of a globally unique access and mobility management function (AMF) identifier, a user equipment next generation (NG) application protocol identifier assigned by an access and mobility management function (AMF) network element, and downlink or uplink tunnel information of each packet data unit session resource.

According to an includes embodiment, the second message further includes information for releasing a resource of a candidate cell on the first node.

According to an embodiment, a third message is transmitted by the first node to the fifth node, the third message includes at least one of information for requesting a direct forwarding path and information for requesting a data forwarding address, and the fifth node is a secondary node of the first node. A fourth message is transmitted by the fifth node to the first node, and the fourth message includes at least one of second information related to the direct forwarding path and second address information related to the data forwarding address.

According to an embodiment, the second information includes at least one of information on whether there is a direct forwarding path between the fifth node and the fourth node, and information on whether there is a direct forwarding path between the fifth node and the third node.

According to an embodiment, the second address information includes at least one of the packet data unit session or data radio bearer-based data forwarding address between the fifth node and the fourth node, and the packet data unit session or data radio bearer-based data forwarding address between the fifth node and the third node.

According to an embodiment, the third message further includes information related to access layer security information of a candidate cell on the fifth node. Here, the information related to the access layer security information of the candidate cell on the fifth node is determined according to security information related to the access layer security information of the candidate cell on the first node.

According to an embodiment, the first message is an LTM Configuration Update message and a Cell Switch Notification message, and the second message may be an LTM Configuration Update Acknowledge message.

According to another aspect of the disclosure, a method performed by a fourth node in a wireless communication system is provided. The method includes receiving a second handover request from a second node, and transmitting a second handover response to the second node, the second handover response comprising context reference information of a user equipment at a third node. Here, the context reference information of the user equipment at the third node includes an identifier of the third node and an identifier assigned by the third node to the user equipment, and the third node is a secondary node of the fourth node. A first handover request is transmitted by the second node to a first node, the first handover request includes the context reference information of the user equipment at the third node, and the first node is a candidate node of the second node.

According to an embodiment, the method further includes transmitting a second addition request to the third node, the second addition request being used to request an addition of the third node as a secondary node to establish dual connectivity for the user equipment, and receiving a second addition response from the third node, the second addition response comprising information related to an acknowledgement of the third node as the secondary node to establish the dual connectivity for the user equipment.

According to an embodiment, the second addition request includes second identifier information of the user equipment. The second identifier information includes at least one of an identifier of the second node and an identifier assigned by the second node to the user equipment. The second addition response further includes resource configuration information of the user equipment at a candidate cell on the third node. The second handover response further includes the resource configuration information of the user equipment at the candidate cell on the third node.

According to an embodiment, the user equipment switches from accessing to the second node to accessing to the fourth node. The method further includes transmitting a first message to the first node. The first message includes at least one of information for requesting a direct forwarding path, information for requesting a data forwarding address, and the identifier assigned by the second node to the user equipment. The method further includes receiving a second message from the first node. The second message includes at least one of first information related to the direct forwarding path, first address information related to the data forwarding address, and an identifier assigned by the first node to the user equipment.

According to an embodiment, the information for requesting the direct forwarding path includes at least one of an identifier of the fourth node and the identifier of the third node.

According to an embodiment, the first information includes information on whether there is a direct forwarding path between the first node and the third node based on a packet data unit session.

According to an embodiment, the first address information includes at least one of a packet data unit session or data radio bearer-based data forwarding address between the first node and the third node, a packet data unit session or data radio bearer-based data forwarding address between a fifth node and the fourth node, and a packet data unit session or data radio bearer-based data forwarding address between the fifth node and the third node. Here, the fifth node is a secondary node of the first node.

According to an embodiment, the first message further includes notification information for releasing a resource of a candidate cell on the fourth node, and the notification information includes identifier information of a to-be-released candidate cell on the fourth node.

According to an embodiment, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

According to an embodiment, the access layer security information of the candidate cell on the first node includes at least one of an identifier of the candidate cell on the first node, an LTM configuration identifier, a key of the candidate cell, and a next hop chaining counter

According to an embodiment, the first message further includes at least one of a globally unique access and mobility management function (AMF) identifier, a user equipment next generation (NG) application protocol identifier assigned by an access and mobility management function (AMF) network element, and downlink or uplink tunnel information of each packet data unit session resource.

According to an embodiment, the second message further includes information for releasing a resource of a candidate cell on the first node.

According to an embodiment, a third message is transmitted by the first node to the fifth node, the third message includes at least one of information for requesting a direct forwarding path and information for requesting a data forwarding address, and the fifth node is the secondary node of the first node. A fourth message is transmitted by the fifth node to the first node, and the fourth message includes at least one of second information related to the direct forwarding path and second address information related to the data forwarding address.

According to an embodiment, the second information includes at least one of information on whether there is a direct forwarding path between the fifth node and the fourth node, and information on whether there is a direct forwarding path between the fifth node and the third node.

According to an embodiment, the second address information includes at least one of the packet data unit session or data radio bearer-based data forwarding address between the fifth node and the fourth node, and the packet data unit session or data radio bearer-based data forwarding address between the fifth node and the third node.

According to an embodiment, the third message further includes information related to access layer security information of a candidate cell on the fifth node. Here, the information related to the access layer security information of the candidate cell on the fifth node is determined according to security information related to the access layer security information of the candidate cell on the first node.

According to an embodiment, the first message is an LTM Configuration Update message and a Cell Switch Notification message, and the second message may be an LTM Configuration Update Acknowledge message.

According to an embodiment, the method further includes receiving a first handover response from the first node. The first handover response includes information related to the addition of the third node as the secondary node.

According to an embodiment, the second handover response further includes resource configuration information of the user equipment at a candidate cell on the third node.

According to another aspect of the disclosure, a method performed by a user equipment in a wireless communication system is provided. The method includes receiving a Radio Resource Control (RRC) Reconfiguration message from a second node, the RRC Reconfiguration message comprising cell configuration information of a fourth node and a third node, and transmitting an RRC Reconfiguration Complete message to the second node, wherein a second handover request is transmitted by the second node, a second handover response is transmitted by the fourth node, the second handover response includes context reference information of the user equipment at the third node, wherein the context reference information of the user equipment at the third node includes an identifier of the third node and an identifier assigned by the third node to the user equipment, and the third node is a secondary node of the fourth node, wherein a first handover request is transmitted by the second node to a first node, the first handover request includes the context reference information of the user equipment at the third node, and the first node is a candidate node of the second node.

According to an embodiment, the user equipment switches from accessing to the second node to accessing to the fourth node. A first message is transmitted by the fourth node to the first node, and the first message includes at least one of information for requesting a direct forwarding path, information for requesting a data forwarding address, and an identifier assigned by the second node to the user equipment. A second message is transmitted by the first node to the fourth node, and the second message includes at least one of first information related to the direct forwarding path, first address information related to the data forwarding address, and an identifier assigned by the first node to the user equipment.

According to an embodiment, the information for requesting the direct forwarding path includes at least one of an identifier of the fourth node and the identifier of the third node.

According to an embodiment, the first information includes information on whether there is a direct forwarding path between the first node and the third node based on a packet data unit session.

According to an embodiment, the first address information includes at least one of a packet data unit session or data radio bearer-based data forwarding address between the first node and the third node, a packet data unit session or data radio bearer-based data forwarding address between a fifth node and the fourth node, and a packet data unit session or data radio bearer-based data forwarding address between the fifth node and the third node. Here, the fifth node is a secondary node of the first node.

According to an embodiment, the first message further includes notification information for releasing a resource of a candidate cell on the fourth node, and the notification information includes identifier information of a to-be-released candidate cell on the fourth node.

According to an embodiment, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

According to an embodiment, the access layer security information of the candidate cell on the first node includes at least one of an identifier of the candidate cell on the first node, an LTM configuration identifier, a key of the candidate cell, and a next hop chaining counter.

According to an embodiment, the first message further includes at least one of a globally unique access and mobility management function (AMF) identifier, a user equipment next generation (NG) application protocol identifier assigned by an access and mobility management function (AMF) network element, and downlink or uplink tunnel information of each packet data unit session resource.

According to an embodiment, the second message further includes information for releasing a resource of a candidate cell on the first node.

According to an embodiment, a third message is transmitted by the first node to the fifth node, the third message includes at least one of information for requesting a direct forwarding path and information for requesting a data forwarding address, and the fifth node is the secondary node of the first node. A fourth message is transmitted by the fifth node to the first node, and the fourth message includes at least one of second information related to the direct forwarding path and second address information related to the data forwarding address.

According to an embodiment, the second information includes at least one of information on whether there is a direct forwarding path between the fifth node and the fourth node, and information on whether there is a direct forwarding path between the fifth node and the third node.

According to an embodiment, the second address information includes at least one of the packet data unit session or data radio bearer-based data forwarding address between the fifth node and the fourth node, and the packet data unit session or data radio bearer-based data forwarding address between the fifth node and the third node.

According to an embodiment, the third message further includes information related to access layer security information of a candidate cell on the fifth node. Here, the information related to the access layer security information of the candidate cell on the fifth node is determined according to security information related to the access layer security information of the candidate cell on the first node.

According to an embodiment, the first message is an LTM Configuration Update message and a Cell Switch Notification message, and the second message may be an LTM Configuration Update Acknowledge message.

According to an embodiment, the method further includes receiving a first handover response from the first node. The first handover response includes information related to the addition of the third node as the secondary node.

According to an embodiment, the second handover response further includes resource configuration information of the user equipment at a candidate cell on the third node.

According to another aspects of the disclosure, a first node, a second node, a third node, a fourth node and a UE that perform the above methods are provided.

in accordance with another aspect of the disclosure, a computer readable storage medium is provided. The computer readable storage medium stores a computer executable instruction. When the computer executable instruction is executed by a processor, the processor performs the above method performed by the first node, the second node, the third node, the fourth node or the UE.

According to the implementations of the disclosure, it can be implemented that different candidate master nodes select the same candidate secondary node to establish dual connectivity for the user equipment, thereby avoiding wasting resources.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a system architecture evolved to a system architecture according to an embodiment of the disclosure;

FIG. 2 is a system architecture according to an embodiment of the disclosure;

FIG. 3 is a flowchart of a handover resource preparation process according to an embodiment of the disclosure;

FIGS. 4A and 4B are a flowchart of a configuration of a mechanism such as data forwarding between nodes according to various embodiments of the disclosure;

FIG. 5 is a flowchart of a method performed by a first node according to an embodiment of the disclosure;

FIG. 6 is a flowchart of a method performed by a second node according to an embodiment of the disclosure;

FIG. 7 is a flowchart of a method performed by a third node according to an embodiment of the disclosure;

FIG. 8 is a flowchart of a method performed by a fourth node according to an embodiment of the disclosure;

FIG. 9 is a flowchart of a method performed by a UE according to an embodiment of the disclosure; and

FIG. 10 illustrates a structure of each node applicable according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

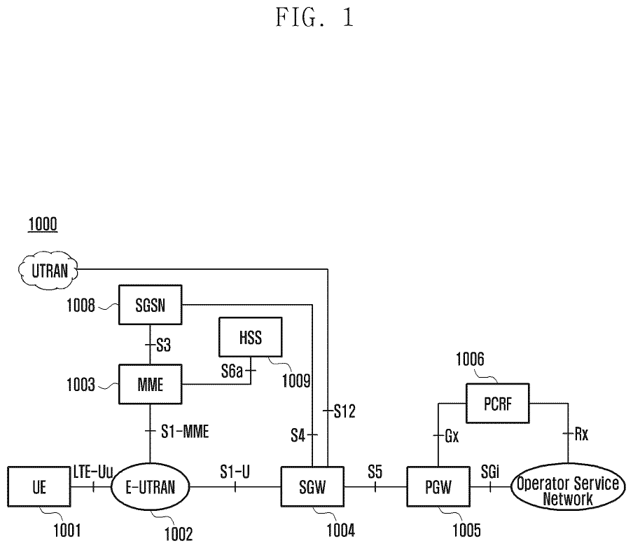

FIGS. 1 to 3, 4A, 4B, and 5 to 10 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is a system architecture 1000 of system architecture evolution (SAE) according to an embodiment of the disclosure.

User equipment (UE) 1001 is a terminal device for receiving data. An evolved universal terrestrial radio access network (E-UTRAN) 1002 is a radio access network, which includes a macro base station (eNodeB/NodeB) that provides UE with interfaces to access the radio network. A mobility management entity (MME) 1003 is responsible for managing mobility context, session context and security information of the UE. A serving gateway (SGW) 1004 mainly provides functions of user plane, and the MME 1003 and the SGW 1004 may be in the same physical entity. A packet data network gateway (PGW) 1005 is responsible for functions of charging, lawful interception, etc., and may be in the same physical entity as the SGW 1004. A policy and charging rules function entity (PCRF) 1006 provides quality of service (QoS) policies and charging criteria. A general packet radio service support node (SGSN) 1008 is a network node device that provides routing for data transmission in a universal mobile telecommunications system (UMTS). A home subscriber server (HSS) 1009 is a home subsystem of the UE, and is responsible for protecting user information including a current location of the user equipment, an address of a serving node, user security information, and packet data context of the user equipment, etc.

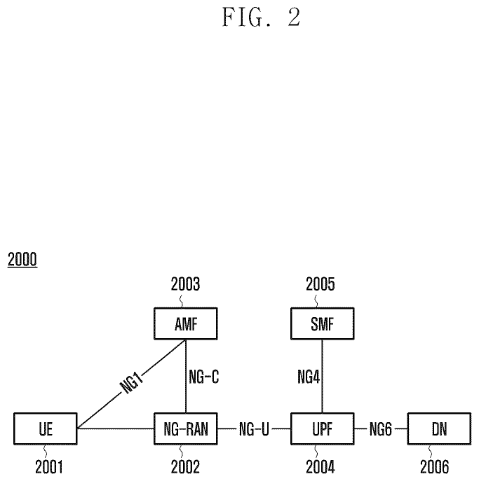

FIG. 2 is a system architecture 2000 according to an embodiment of the disclosure.

Other embodiments of the system architecture 2000 can be used without departing from the scope of the disclosure. User equipment (UE) 2001 is a terminal device for receiving data. A next generation radio access network (NG-RAN) 2002 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 2003 is responsible for managing mobility context and security information of the UE. A user plane function entity (UPF) 2004 mainly provides functions of user plane. A session management function entity SMF 2005 is responsible for session management. A data network (DN) 2006 includes, for example, services of operators, access of Internet and service of third parties.

For the convenience of description, some technical terms involved in the following description of the embodiments of the disclosure and their explanations are as follows:
1. L1/L2 Triggered Mobility (LTM): layer 1/layer 2 triggered mobility.
2. Subsequent Conditional primary secondary cell (PSCell) Addition or Change, subsequent CPAC (SCPAC): a continuous (or subsequent) conditional primary secondary cell addition or change. After a primary secondary cell (PSCell) addition, a PSCell change, a primary cell (PCell) change or a secondary cell group (SCG) release, a conditional PSCell increase procedure or a conditional PSCell change procedure is performed based on the subsequent CPAC configuration of a pre-configured candidate PSCell without reconfiguring and restarting the conditional primary secondary cell (PSCell) change (CPC) and/or the conditional primary secondary cell (PSCell) addition (CPA).
3. Conditional handover (CHO). For example, a handover procedure is performed only when an evaluation condition is satisfied. The network side preconfigures resources of a plurality of candidate cells (the plurality of candidate cells may be positioned at the same base station or may be positioned at different base stations) based on the measurement report of the UE, and transmits the resource and measurement configuration corresponding to each candidate cell to the UE in advance. The UE saves the corresponding resource of each candidate cell and performs a measurement to perform a condition evaluation. After finding that a candidate cell satisfies a condition, the UE leaves the source cell and successfully accesses the candidate cell (e.g., a target cell) satisfying the condition, and then applies the corresponding configuration. Then, the UE releases all configurations of other candidate cells, and at the same time, the base station (or node) to which the target cell belongs notifies the source base station (or node) of which candidate cell is selected. Then, the network side performs the operation of releasing all the configurations of the other candidate cells.
4. AMF: an access and mobility management function, which is a network element of a 5G core network and is responsible for the access and mobility management of a 5G base station, the 5G base station and the AMF being connected through an NG-C interface.
5. NG-RAN node: a new generation radio access network node, for example, a 5G base station, including a gNB or an ng-eNB.
6. Next Generation Node B (gNB): a next generation base station node, for example, a 5G NR (New Radio) base station.
7. gNB-DU: a gNB distributed unit, which has functions such as a radio link control (RLC) protocol, a medium access control (MAC) protocol and a physical layer (PHY) protocol.
8. gNB-CU: a gNB central unit, which has functions such as a radio resource control (RRC) protocol, a service data adaptation protocol (SDAP) and a packet data convergence protocol (PDCP).
9. NR-NR Dual Connectivity (NR-DC): a new radio-new radio dual connectivity, or a next generation radio access network dual connectivity.
10. MN: a master node.
11. SN: a secondary node.
12. MCG: a master cell group, which is a group of serving cells associated with a master node in a radio access network dual connectivity (MR-DC) and includes an SpCell (specifically, the primary cell (PCell) of the master cell group), and optionally includes one or more secondary cells (SCells).
13. SCG: a secondary cell group, which is a group of serving cells associated with a secondary node in the radio access network dual connectivity (MR-DC) and includes an SpCell (, specifically, the primary cell (PSCell) of the secondary cell group), and optionally includes one or more secondary cells (SCells).
14. SpCell: the primary cell of a master cell group or a secondary cell group.
15. SpCell: a special cell, for example, a primary cell serving a UE (the primary cell of a master cell group or a secondary cell group).
16. PSCell: a primary secondary cell, for example, the primary cell (SpCell) of a secondary cell group.
17. PCell: a primary cell, for example, the primary cell (SpCell) of a master cell group.
18. Multi-Radio Dual Connectivity (MR-DC): dual connectivity between an evolved-universal terrestrial radio access (E-UTRA) node and an NR node, or between an NR node and an NR node.

It should be understood that the message names used in the disclosure are examples only and other names may also be adopted. The information transmitted between interfaces may be implemented by a separately defined new message, or by an added information element (IE) in an existing message in an existing corresponding interface specification.

Various embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

The entities and/or nodes in the disclosure may include a gNB, a gNB central unit (gNB-CU), a gNB distributed unit (gNB-DU), a gNB central unit control plane (gNB CU-CP), a gNB central unit user plane (gNB CU-UP), an en-gNB, an eNB, an ng-eNB, a UE, an access and mobility management function (AMF), a session management function (SMF), a mobility management entity (MME), or other network entities or network logic units.

The handover described in the disclosure may include one or more of: a handover, a secondary node addition, a secondary node change, a master node change, etc.

In the disclosure, the node may refer to a node or may refer to a cell managed by the node.

In the disclosure, the cell may refer to a cell or a node where the cell is.

In the disclosure, a source node may refer to a source node in any handover, for example, a source node, a source secondary node, a source master node.

In the disclosure, a target node may also refer to a candidate target secondary node.

In the disclosure, the target node may refer to a target node in any handover, for example, a target node, a target secondary node, a target master node, a candidate target node, a candidate target source node, and a candidate target master node.

In the disclosure, the target node may refer to one or more of: a target gNB CU, a target gNB DU, a target gNB CU-CP, a target gNB CU-UP, etc.

In the disclosure, the source node may refer to one or more of: a source gNB CU, a source gNB DU, a source gNB CU-CP, a source gNB CU-UP, etc.

In the disclosure, a master node and a master base station are equivalent, a secondary node and a secondary base station are equivalent, a source node and a source base station are equivalent, a target node and a target base station are equivalent, a candidate node and a candidate base station are equivalent, a source master node and a source master base station are equivalent, a target master node and a target master base station are equivalent, a candidate master node and a candidate master base station are equivalent, a source secondary node and a source secondary base station are equivalent, a target secondary node and a target secondary base station are equivalent, and a candidate secondary node and a candidate secondary base station are equivalent.

In the disclosure, the message names are examples only, and other message names may also be adopted.

In the disclosure, “first,” “second,” etc. contained in the message names are only used to distinguish one message from another message, and do not represent the execution or transmission order.

In the disclosure, the detailed description of the steps irrelevant to the disclosure is omitted.

In the disclosure, the steps in each process may be performed in combination with each other, or performed separately. The execution steps in each process are merely examples, and do not rule out other possible execution steps and/or orders.

In the disclosure, a base station may be a 6G base station, a 5G base station (e.g., a gNB, and an ng-eNB), a 4G base station (e.g., an eNB), a RAN node, or another type of access node.

Different embodiments of the above process are described below based on the addition or release of a secondary base station or the addition of the same secondary base station or different secondary base stations that may occur in an inter-base station node LTM scenario. The nodes involved in the scenario include the following nodes:
1. Source Master Node: a base station of a PCell currently serving a user equipment.
2. Source Secondary Node: a base station of a PSCell currently serving the user equipment
3. Candidate Master Node (or Target Master Node): a serving base station of a candidate primary cell (PCell) or a serving base station of a target primary cell prepared for the user equipment.
4. Candidate Secondary Node (or Target Secondary Node): a serving base station of a candidate primary secondary cell (PSCell) or a serving base station of a target primary secondary cell prepared for the user equipment. Further, for the LTM scenario of the master cell group without a secondary node change, the secondary node serving the user equipment does not change in the process of preparing the candidate cell or the target cell (that is, if the user equipment switches to the candidate cell, the above source secondary node is still the secondary node serving the user equipment, that is, the candidate secondary node or the target secondary node is the same as the source secondary node), but the PSCell serving the user equipment may change, or may not change.

In the following embodiments, considering that the candidate secondary node or the target secondary node is the same as the source secondary node, the “source secondary node” is used to represent the base station of the secondary cell group serving the user equipment.

In the configuration process of an initial candidate cell, the source node (the source master node and/or the source secondary node) and the candidate node (the candidate master node and/or the candidate secondary node) can normally implement a data forwarding mechanism. However, if the mobility of the UE supports the continuity (subsequent) mechanism, that is, the configuration of the initially prepared candidate cell is reserved after the UE switches to a candidate node, the UE may continue to perform the handover unless the configuration of the resource of the candidate cell for the UE is explicitly released. However, the mobility support continuity mechanism remains to be further improved.

In the dual connectivity configuration, the user equipment is served by the source master node and the source secondary node. To prepare a candidate cell, the source node may transmit a request for a candidate cell preparation to another node (the target master node, the target node, or the candidate master node, or the candidate node). Further, the other node may further configure a dual connectivity with a new secondary node or a dual connectivity with the current source secondary node for the user equipment, or configure only a single connectivity in which the user equipment is only served by the master node. Similarly, when the UE is in a single connectivity situation (i.e., only one node serves the UE, and the UE is initially not in a dual connectivity service state), in order to prepare a candidate cell, the source node may transmit a request for a candidate cell preparation to another node (the target master node, the target node, or the candidate master node, or the candidate node). Further, the other node may further configure a dual connectivity with a new secondary node, or a single connectivity in which the user equipment is only served by the master node.

However, when the other node further configures the dual connectivity for the user, it is irregular for the other node to select which candidate secondary node to establish the dual connectivity for the UE based on the measurement report of the UE. For example, the other node may select the same candidate secondary node as the above candidate secondary node selected by the candidate master node (another other node) to establish the dual connectivity for the UE, and may alternatively select a different candidate secondary node. However, always selecting different candidate secondary nodes to establish the dual connectivity may cause a resource waste situation.

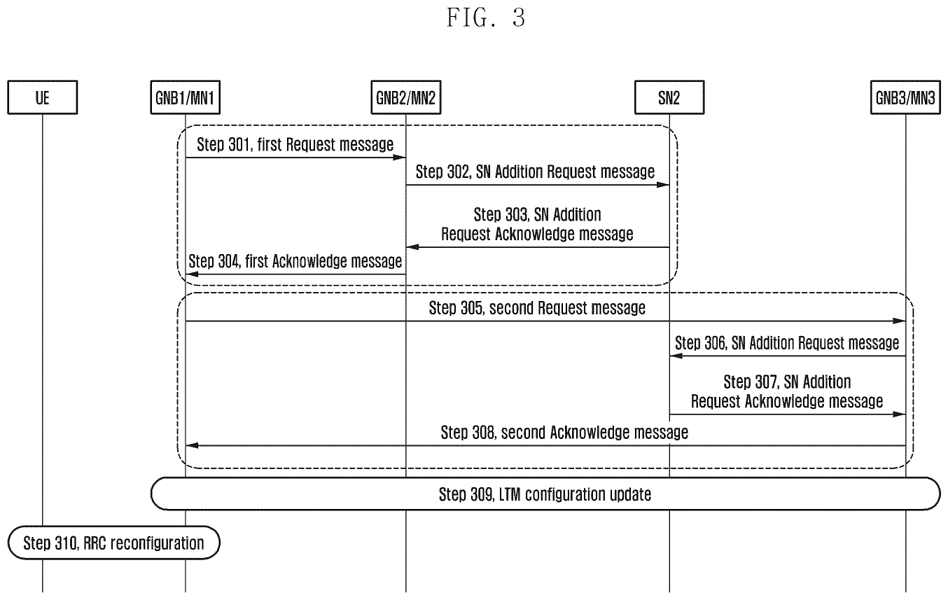

FIG. 3 is a flowchart of a handover resource preparation process a according to an embodiment of the disclosure. This embodiment comprises the following operations.

In operation 301, transmitting, by a source master node (assuming that a UE is initially in a dual connectivity service state) or a source node (assuming that the UE is initially not in the dual connectivity service state), a first request message to a candidate master node or a candidate node.

For example, the first request message may be a Handover Request message or another message, and the first request message may be used to request a resource for the establishment of the candidate cell for the UE.

In combination with FIG. 3, the source master node may be represented by MN1, the source node may be represented by GNB1, the candidate master node may be represented by MN2, and the candidate node may be represented by GNB2.

In operation 302, transmitting, by the candidate master node or the candidate node, an SN Addition Request (S-Node Addition Request) message to a candidate secondary node.

As an example, the candidate master node (or candidate node) may establish dual connectivity for the UE in order to improve the service performance such as a UE throughput. Moreover, when establishing the dual connectivity for the UE, the candidate master node may select a source secondary node (assuming that the UE is initially under the dual connectivity), a new candidate secondary node, or an identical candidate secondary node (i.e., identical to the candidate secondary node selected by another candidate master node).

Optionally, the SN Addition Request message may include an identifier of a user equipment for identifying the user equipment. The candidate secondary node (SN2 in FIG. 3) identifies whether the SN addition requests from different candidate master nodes are for the same UE, based on the identifier of the user equipment in the SN Addition Request message.

For example, if the different candidate master nodes each select a different candidate secondary node when selecting the candidate secondary node, then the candidate cell resources prepared for the UE are different, resulting in the waste of resources. If the candidate secondary node identifies that the SN addition requests from the different candidate master nodes are for the same UE, the same set of PSCell resources may be established for the same UE, which can avoid wasting resources.

As an example, the identifier of the user equipment may include at least one of: a Source NG-RAN node ID (the identifier of a source node serving the UE, i.e., the identifier of the initial source node of the UE before the handover), a Source NG-RAN node UE XnAP ID (a UE Xn application protocol (XnAP) ID assigned by the source node serving the UE), a Source M-NG-RAN node ID (the identifier of a source master node serving the UE, i.e., the identifier of the initial source master node of the UE before the handover), and a Source M-NG-RAN node UE XnAP ID (the UE XnAP ID assigned by the source master node serving the UE).

In operation 303, transmitting, by the candidate secondary node, an SN Addition Request Acknowledge message (S-Node Addition Request Acknowledge) to the candidate master node or the candidate node.

Optionally, the candidate secondary node performs a determination through the identifier of the user equipment carried in the SN Addition Request message. If it is identified that the SN Addition Request messages from different candidate master nodes are for the same UE, the same resource is established for the same PSCell selected, to avoid wasting resources. After the resource configuration of the candidate PSCell is completed, an SN Addition Request Acknowledge message is transmitted to the candidate master node or the candidate node. The SN Addition Request Acknowledge message may include the resource information of the candidate cell configured for the UE.

In operation 304, transmitting, by the candidate master node or the candidate node, a first acknowledge message to the source master node or the source node.

For example, the first acknowledge message may be a Handover Request Acknowledge message or another message.

As an example, after completing the resource configuration of the candidate cell, the candidate master node returns the Handover Request Acknowledge message to the source master node or the source node.

Optionally, the first acknowledge message may include the UE context reference information at the candidate secondary node. The source master node or the source node receives the first acknowledge message, and
the information (the UE context reference information at the candidate secondary node) may be carried to be transmitted to the other candidate master node when the handover request is triggered to the other candidate node (e.g., the GNB3/MN3 in FIG. 3), such that the other candidate master node initiates an SN addition request to the candidate secondary node indicated by the information. Thus, different candidate master nodes may select the same candidate secondary node to establish the dual connectivity for the user equipment, which can reduce the resource waste.

As an example, the UE context reference information at the candidate secondary node (UE Context Reference at the S-NG-RAN node) may include at least one of: an identifier of the candidate secondary node (S-NG-RAN node ID) and an UE XnAP ID (S-NG-RAN node UE XnAP ID) assigned by the candidate secondary node to the UE.

Optionally, the first acknowledge message may include the resource information of the candidate cell configured for the UE and obtained in operation 303.

In operation 305, transmitting, by the source master node or the source node, a second request message to another candidate master node or another candidate node.

For example, the second request message may be a Handover Request message or another message, and the second request message may be used to request a resource for the establishment of the candidate cell for the UE.

After the source master node or the source node and at least one candidate master node (e.g., the GNB2/MN2 in FIG. 3) complete the resource preparation process, if the candidate master node establishes the dual connectivity for the UE, and the source master node or the source node expects that another candidate master node (e.g., the GNB3/MN3 in FIG. 3) establishes a dual link for the UE on the same candidate secondary node (alternatively, a set of resources may be prepared on the same PSCell to save resources) during the resource preparation process, the above UE context reference information at the candidate secondary node may be carried when the Handover Request message is triggered to the other candidate node, to expect that the other candidate node may initiate the SN addition request to the candidate secondary node indicated in the above information (e.g., the UE context reference information at the candidate secondary node) if the other candidate node establishes the dual connectivity for the UE.

Optionally, the second request message may include at least one of: the UE context reference information at the candidate secondary node, an NG-RAN node ID (indicating the ID of the candidate master node that has established the dual connectivity for the UE, for example, the GNB2 ID or MN2 ID shown in FIG. 3), and an S-NG-RAN node UE XnAP ID (indicating the above UE XnAP ID assigned to the UE by the candidate secondary node (e.g., the SN2 shown in FIG. 3) selected by the candidate master node establishing the dual connectivity for the UE). The second request message may be used to suggest that the candidate master node initiates the SN addition request to the candidate secondary node indicated by the above information (e.g., the UE context reference information at the candidate secondary node), to establish the dual connectivity for the UE.

For example, the UE context reference information at the candidate secondary node may be a list including UE context references at one or more recommended candidate secondary nodes, for example, different or identical candidate secondary nodes (clearly, which may include the source secondary node) added by different candidate master nodes during the above handover preparation process (prior to operation 305).

For example, the UE context reference information at the candidate secondary node (UE Context Reference at the S-NG-RAN node) may include at least one of: the ID (S-NG-RAN node ID) of the candidate secondary node selected by the candidate master node establishing the dual connectivity for the UE, and the UE XnAP ID (S-NG-RAN node UE XnAP ID) assigned to the UE by the candidate secondary node selected by the candidate master node establishing the dual connectivity for the UE.

In operation 306, transmitting, by the other candidate master node or the other candidate node, an SN Addition Request message to a candidate secondary node suggested in the second request message.

As an example, the other candidate master node or the other candidate node receives the second request message, and transmits, according to the UE context reference information at the candidate secondary node, the SN Addition Request message to the candidate secondary node suggested by the source master node or the source node. For example, in combination with FIG. 3, the MN2 selects the SN2 to establish the dual connectivity, and the MN3 selects the SN2 to establish the dual connectivity based on the candidate secondary node SN2 suggested in the second request message. Accordingly, it can be implemented that different candidate master nodes select the same candidate secondary node to establish the dual connectivity for the user equipment, which can save resources.

Optionally, the SN Addition Request message may include an identifier of a user equipment for identifying the user equipment. The candidate secondary node may identify which UE the SN Addition Request message is for, according to the identifier of the user equipment.

As an example, the SN Addition Request message in operation 306 may include at least one of: a Source NG-RAN node ID (the identifier of a source node serving the UE, the identifier of the initial source node of the UE before the handover), a Source NG-RAN node UE XnAP ID (a UE Xn application protocol (XnAP) ID assigned by the source node serving the UE), a Source M-NG-RAN node ID (the identifier of a source master node serving the UE, the identifier of the initial source master node of the UE before the handover), a Source M-NG-RAN node UE XnAP ID (the UE XnAP ID assigned by the source master node serving the UE), an S-NG-RAN node ID (the ID of the candidate secondary node that has establishes the dual connectivity for the UE), an S-NG-RAN node UE XnAP ID (the UE XnAP ID assigned to the UE by the candidate secondary node selected by the candidate master node establishing the dual connectivity for the UE), an NG-RAN node ID (indicating that the ID of the candidate master node that has establishes the dual connectivity for the UE), and an NG-RAN node UE XnAP ID (the UE XnAP ID assigned to the UE by the candidate master node). For example, the identifier of the user equipment in the SN Addition Request message in operation 306 may include at least one of the above identifiers.

In operation 307, transmitting, by the candidate secondary node, an SN Addition Request Acknowledge message to the other candidate master node or the other candidate node.

Optionally, the candidate secondary node may identify which UE the resource of the candidate secondary node is prepared for according to the identifier of the user equipment. If it is identified that the SN Addition Request message in operation 306 and the SN Addition Request message described above (e.g., the SN Addition Request message in operation 303) are SN addition requests for the same UE, the candidate secondary node may establish the same set of candidate cell resources for the same UE, for example, prepare the same set of resources for the same UE on the same PSCell, which can further avoid wasting the resources.

For example, after completing the resource configuration of the candidate PSCell, the candidate secondary node transmits the SN Addition Request Acknowledge message to the other candidate master node or the other candidate node. The SN Addition Request Acknowledge message may include the resource information of the candidate cell configured for the UE. If it is identified that the SN Addition Request message in operation 306 and the SN Addition Request message in operation 303 are SN addition requests for the same UE, the resource information of the candidate cell configured for the UE and obtained in operation 307 may be the same as the resource information of the candidate cell configured for the UE and obtained in operation 303. In this way, not only can different candidate master nodes select the same candidate secondary node to establish the dual connectivity for the user equipment, but also the same set of candidate cell resources can be established for the same UE, which can avoid wasting the resources.

In operation 308, transmitting, by the other candidate master node or the other candidate node, a second acknowledge message to the source master node or the source node.

For example, the second acknowledge message may be a Handover Request Acknowledge message or another message.

As an example, after completing the resource configuration of the candidate cell, the other candidate master node or the other candidate node returns the Handover Request Acknowledge message to the source master node or the source node.

Optionally, the second acknowledge message may include at least one of: the UE context reference information at the candidate secondary node, and an acknowledgement for an addition of the candidate secondary node suggested in the second request message to establish dual connectivity.

Optionally, the second acknowledge message may include the resource information of the candidate cell configured for the UE and obtained in operation 307.

Optionally, the number of the other candidate master nodes or the other candidate nodes in the method shown in FIG. 3 is not defined in the disclosure, and for the handover resource preparation process of these other candidate master nodes or other candidate nodes, reference may be made to the above operations 305-308.

In operation 309, performing, by the source node and the candidate node, an LTM configuration update. After the preparation of the handover resources is completed between the source node and the candidate node, the resource configuration information of the accepted candidate cell and the channel state information-reference signal (CSI-RS) resource configuration information of the candidate cell are collected to generate common CSI-RS resource configuration information. Then, a resource configuration update procedure needs to be initiated to each candidate node to transmit the common CSI-RS resource configuration information, such that the candidate cell of the candidate node generates a CSI-RS report configuration, and then each candidate node replies to the source node through an LTM Configuration Update Acknowledge message, and accordingly, the source node configures the UE through an RRC Reconfiguration message in operation 310.

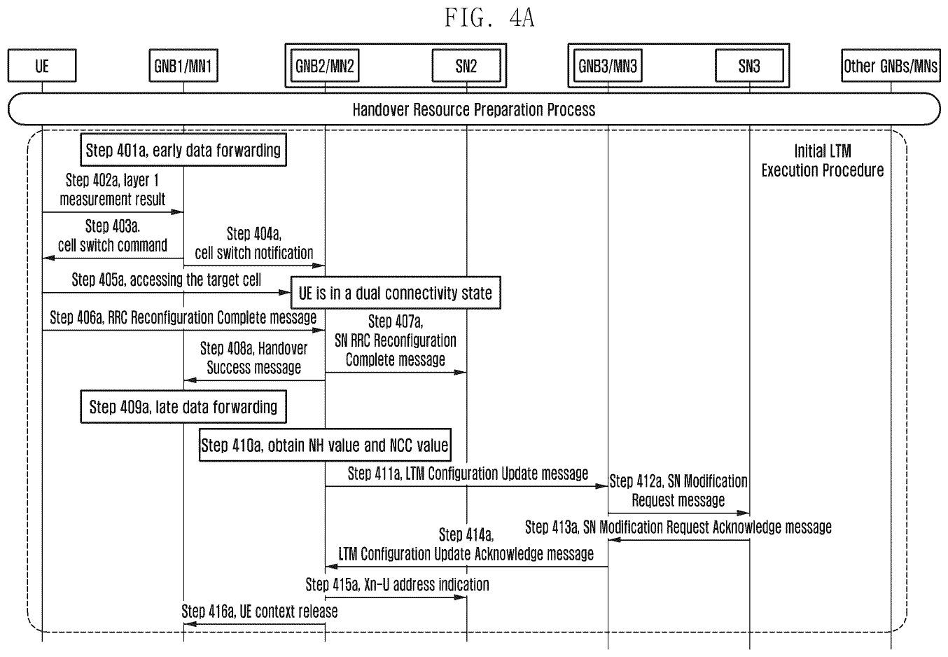

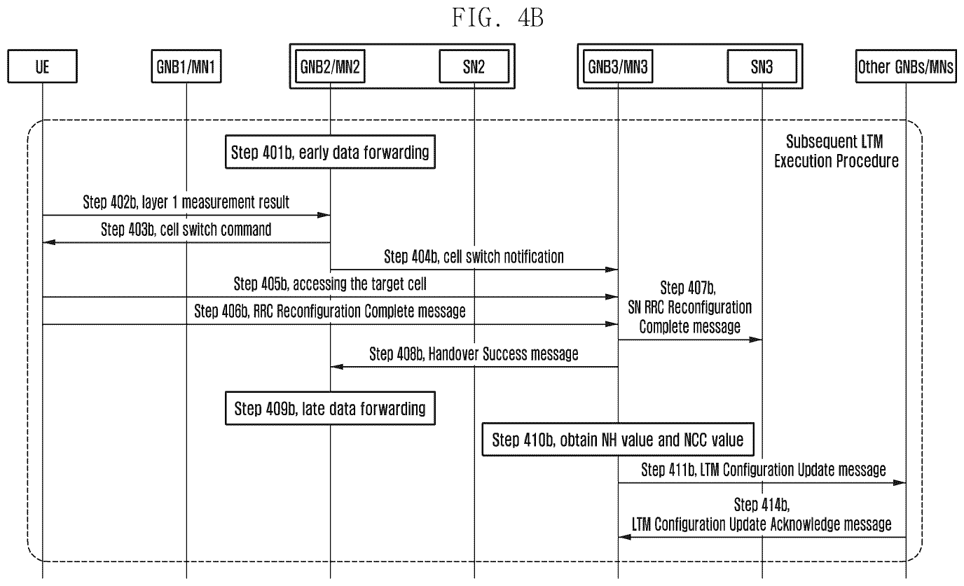

In order to be able to implement a mechanism such as data forwarding in a subsequent handover procedure of the mobility support continuity mechanism, a network node needs to perform a corresponding configuration after the initial handover is performed or after each handover is performed. The method shown in FIGS. 4A and 4B can support data forwarding in a continuous handover execution process, which can reduce the impact on the data service for the UE, thereby ensuring the data service for the user equipment.

FIGS. 4A and 4B are a flowchart of a configuration of a mechanism such as data forwarding between nodes according to various embodiments of the disclosure. This embodiment includes the following operations. Through the above embodiment of FIG. 3, the handover resource preparation process is completed, and the source node completes the configuration for the UE through an RRC reconfiguration procedure. The method shown in FIGS. 4A and 4B in the embodiment of the disclosure may be used in combination with the method shown in FIG. 3, for example, operation 401 may be performed after operation 310, or may be used alone.

In operation 401, acquiring, by a source node, data forwarding addresses of a candidate master node and a candidate secondary node through a handover request procedure, and then initiating early data forwarding.

Similar to the method shown in FIG. 3, MN1 may represent a source master node, and GNB1 may represent the source node. The source node is taken below as an example for description.

Next, a network may trigger a UE to perform an early timing advance (TA) acquisition procedure.

In operation 402, transmitting, by a UE, a layer 1 measurement result of a candidate cell to the source node according to a measurement configuration.

In operation 403, transmitting, by the source node, a cell switch command to the UE to indicate related information such as a target cell to the UE, when triggering LTM.

In operation 404, transmitting, by the source node, a Cell Switch Notification message to a target node to which the target cell belongs, the Cell Switch Notification message carrying related information of the target cell.

In order for the target node to obtain the information of other candidate nodes, the source node may initiate a resource configuration update procedure to each candidate node in the handover resource preparation process in FIG. 3. By using the LTM Configuration Update message to carry the Multiple Candidate NG-RAN Node List information described below, each candidate node obtains a candidate cell accepted during the configuration and the information of a candidate node to which the candidate cell in advance, which helps the candidate node, when being accessed by the UE to become a new source node, know which other candidate nodes to transmit the LTM configuration update procedure to for the assignment of a UE XnAP ID to associate with the context of the UE. If the information of the candidate cell and the node to which the candidate cell belongs is not carried in the previous LTM configuration update procedure, the Multiple Candidate NG-RAN Node List information may be carried in the Cell Switch Notification message when the UE handover is triggered.

Optionally, the Multiple Candidate NG-RAN Node List information may include at least one of: the ID of each candidate node, the information of a candidate cell on each candidate node, and the ID information of the candidate cell.

For example, if the source node is also configured as a candidate node, the ID (candidate NG-RAN node ID) of each candidate node includes the ID of the source node. The ID may be a global NG-RAN node ID, or may be a global gNB ID or a global ng-eNB ID.

For example, if a source cell or another cell on the source node is also configured as a candidate cell, the information (candidate cell list) of the candidate cell on each candidate node includes the corresponding cell.

For example, if the source cell is also configured as a candidate cell, the ID information (candidate cell ID) of the candidate cell includes the source cell. The ID may be a cell ID or an NR cell global ID (CGI).

In operation 405, accessing, by the UE, the target cell after receiving the cell switch command.

If the target node configures dual connectivity for the UE, that is, the configuration of the target cell includes an SCG configuration, an optimal candidate PSCell is selected according to the radio signal quality of one or more candidate PSCells associated with a target PCell, and then the access to the target PSCell is performed according to whether an SCG radio bearer is configured.

In operation 406, transmitting, by the UE, an RRC Reconfiguration Complete message to the target node after successfully accessing the target cell.

If the UE also applies an SCG configuration associated with the candidate cell, an SN RRC Reconfiguration Complete message will be embedded in the RRC Reconfiguration Complete message to be transmitted to a target SN, indicating the information of the selected PSCell cell (e.g., a cell frequency, a PCI or cell ID/CGI information).

In operation 407, transmitting, by the target node, an SN RRC Reconfiguration Complete message to a target SN if the SN RRC Reconfiguration Complete message is carried in the operation 406.

In operation 408, transmitting, by the target node, a Handover Success message to the source node to notify that the UE successfully accesses the target cell.

In operation 409, stopping, by the source node, transmitting data to the UE, and starting to forward late data to the target node.

In operation 410, performing, by the target node and a core network, a path switch procedure after a successful handover of the UE to the target node, to obtain a new NH (next hop) parameter and an NCC (next hop chaining counter) value from the core network.

Here, for the UE configured with a continuous handover (including mobility procedures such as LTM and CHO), the target node may use a Path Switch Request message to carry a continuous handover indication (such as an LTM indication and a subsequent handover/LTM), to expect the trigger of the core network for the continuous inter-CU/gNB handover/LTM. The address information of the control plane and the user plane of the UE on the NG interface at the core network side may not change, other configurations may remain unchanged, and no modification (such as a management based MDT PLMN list, and UL NG-U UP TNL information) is made, so as to avoid that the UE needs to transmit the information for the notification of the modification to the candidate node or the target node due to the change in the information after each handover and then the signaling overhead is increased. Clearly, by transmitting the continuous handover indication (such as the LTM indication and the subsequent handover/LTM) to the core network through the Path Switch Request message, in addition to the above purpose, there may be other beneficial effects, which will not be described here one by one.

In operation 411, initiating, by a new source node (i.e., the target node accessed by the UE through the Handover/LTM and then the role of the target node becomes the source node for the next handover/LTM procedure), a resource configuration update procedure (using an LTM Configuration Update message or another message in the configuration procedure of the LTM) to each candidate node (which may include the source node if the source node also acts as a candidate node for the subsequent LTM).

As an example, the LTM Configuration Update message or the other message may carry one or more of: usage indication information, a UE XnAP ID (Source NG-RAN node UE XnAP ID) assigned by the new source node currently serving the UE, UE context reference information of the NG-RAN node serving the UE last time, the ID (Source NG-RAN node ID) of the source node currently serving the UE, the ID (S-NG-RAN node ID) of a source SN node, data forwarding proposal information, LTM modification or update indication, a globally unique AMF identifier GUAMI, an NG-C UE associated signaling reference, an AMF IP address (Signaling TNL association address at source NG-C side) associated with an SCTP used by a source NG-C interface instance, a UE security capability, a radio access technology/frequency selection priority index (Index to RAT/Frequency Selection Priority), a UE aggregate maximum bit rate, DL/UL tunnel information of each PDU session resource (DL/UL tunnel information per PDU Session Resource), location reporting information, a mobility restriction list, a management based MDT PLMN list, a UE radio capability ID, trace activation, the version of blocked or protected (masked) international mobile equipment identity software (IMEISV), UE history information, mobility information, the UE history information from the UE, time synchronization assistance information, a to-be-released/cancelled LTM/candidate cell list (LTM/Candidate Cells To Be Released/Cancelled List), the access layer security information corresponding to one or more candidate cells on the candidate node, and cell information.

Here:

The usage indication information is used to indicate the transmitting of the LTM Configuration Update message or the other message. The information may be used to determine a handover type, and further to determine the signaling of the configuration user to reduce the signaling overhead. The information may be used to indicate at least one of the following usages (which may also be considered as the handover types, and therefore the indication information may also be handover type indication information): a handover (e.g., a layer 3 handover), LTM (or master cell group LTM), a CHO, an inter-base station handover (or a handover between central units of the base stations), and a handover without a secondary node change (or a handover without a primary and secondary cell PSCell change).

For the inter-base station handover (or the handover between the central units of the base stations), in this type of handover, the prepared candidate cell (or target cell) and the serving cell of the user equipment are in different base stations or in the central units of the different base stations. Further, this usage indication information may further indicate one of the following handover types: inter-base station LTM (inter-BS LTM), LTM between the central units of the base stations (inter-BS-CU LTM), inter-base station MCG LTM (inter-BS MCG LTM) and MCG LTM between the central units of the base stations (inter-BS-CU MCG LTM).

For the handover without the secondary node change (or the handover without the primary and secondary cell PSCell change), in this type of handover, the secondary node or PSCell serving the user equipment does not change, but the candidate cell (or target cell) prepared for the user equipment and the serving cell (or source cell) of the user equipment may belong to different base stations or the same base station, or belong to the central units of the different base stations or the same base station.

Optionally, the UE XnAP ID assigned by the new source node (NG-RAN) currently serving the UE may be the same as the target NG-RAN node UE XnAP ID assigned during the handover request procedure or the LTM configuration update procedure occurring at an Xn interface when the node is used as the candidate node last time. That is, the Source NG-RAN node UE XnAP ID assigned this time is set to be the same as the original target NG-RAN node UE XnAP ID, and is associated with the context of the UE on the Xn interface.

For the UE context reference information of the NG-RAN node serving the UE last time, this IE is carried in order to enable the candidate node to identify a UE (which UE the configuration update procedure is performed for). Then, the candidate node assigns an appropriate UE XnAP ID (e.g., Target NG-RAN node UE XnAP ID) to this UE on the Xn interface of the current source node and this candidate node, and the context of this UE is associated on the Xn interface. Optionally, the assigned target NG-RAN node UE XnAP ID may the same as the target NG-RAN node UE XnAP ID in the handover request procedure or the LTM configuration update procedure occurring at the Xn interface between the last time source node and the candidate node, and the context of this UE is associated on the Xn interface.

The UE context reference information of the NG-RAN node serving the UE last time may include at least one of: the ID of the NG-RAN node serving the UE last time (i.e., the ID of the source node performing a handover/LTM procedure last time), and the UE XnAP ID assigned by the NG-RAN node serving the UE last time.

For the ID of the source node currently serving the UE (i.e., Source NG-RAN node ID): this IE is carried in order to query, from the candidate node including the candidate master node and/or the candidate secondary node, whether there is a direct forwarding path with the source node currently serving the UE. After receiving this information, the candidate node determines whether there is the direct forwarding path with the source node currently serving the UE. At the same time, for the candidate secondary node for the dual connectivity, the candidate master node transmits these information to the candidate secondary node through a message, to expect the candidate secondary node to determine whether there is a direct forwarding path with the source node, and then reply to the candidate master node. Then, the candidate master node replies to the source node. If the ID IE of the source node currently serving the UE is included in the LTM Configuration Update message, if supported, the candidate or target NG-RAN node should use the ID IE to determine the availability of a direct data forwarding path with the source node currently serving the UE. If the direct data forwarding path is available, a Direct Forwarding Path Availability IE set to “direct path available” is included in an LTM Configuration Update Acknowledge message, and thus, the direct early data forwarding can be realized, thereby saving forwarding resources.

For the ID (S-NG-RAN node ID) of a source SN node, this IE is carried in order to query, from the candidate node including the candidate master node and/or the candidate secondary node, whether there is a direct forwarding path with the source SN node. After receiving this information, the candidate node determines whether there is the direct forwarding path with the source SN node. At the same time, for the candidate secondary node for the dual connectivity, the candidate master node transmits these information to the candidate secondary node through a message, to expect the candidate secondary node to determine whether there is the direct forwarding path with the source SN node, and then return the result to the candidate master node. Then, the candidate master node returns the result to the source node. If the Source S-NG-RAN node ID IE is included in the LTM Configuration Update message, if supported, the candidate or target NG-RAN node should use the ID IE to determine the availability of the direct data forwarding path with a specified source S-NG-RAN node. If the direct data forwarding path is available, a Direct Forwarding Path Availability IE set to “direct path available” is included in an LTM Configuration Update Acknowledge message, and thus, the direct early data forwarding can be realized, thereby saving forwarding resources. For example, the data forwarding proposal information may be represented by a Data Forwarding and Offloading Information information element from the source NG-RAN node, indicating that the source node requests a data forwarding proposal based on a PDU session (which may be represented by a PDU session ID) and/or a quality of service (QoS) flow (which may be represented by a QoS flow ID) corresponding to a protocol data unit (PDU) session ID.

The data forwarding proposal information may include at least one of: a packet data unit session ID (PDU session ID), a quality of service flow ID (QoS flow ID), a source DRB to QoS flow mapping list, the LTM modification or update indication (e.g., an LTM indication, of which the value may be “modification” or “update”) or the LTM modification or update request.

For the one or more of the following information, if the target node and/or the core network change the corresponding information through the path switch procedure in the above operation 410, the target node and/or the core network need to notify other candidate nodes through the LTM Configuration Update message:
the GUAMI, the NG-C UE associated signaling reference, the AMF IP address associated with the SCTP used by the source NG-C interface instance, the UE security capability, the radio access technology/frequency selection priority index (Index to RAT/Frequency Selection Priority), the UE aggregate maximum bit rate, the DL/UL tunnel information of each PDU session resource, the location reporting information, the mobility restriction list, the management based MDT PLMN list, the UE radio capability ID, the trace activation, the masked IMEISV, the UE history information, the mobility information, the UE history information from the UE, and the time synchronization assistance information.

Here:

For the GUAMI, this IE includes the globally unique AMF identifier, indicating identifier information of the AMF of the current node regarding the NG-C signaling connection.

For the NG-C UE associated signaling reference, that is, the AMF UE NGAP ID, the ID is the UE NGAP ID assigned to a specific UE by the AMF on the AMF side on the NG interface between the NG-RAN node and the AMF. In the path switch procedure in operation 410, the target node receives, from the AMF, the UE NGAP ID assigned by the AMF. The purpose of carrying this information is that the next time when the UE switches to access a new target node to trigger a path switch request procedure to the core network, this IE is carried as a reference, to enable the AMF to identify a UE (i.e., which UE the path switch procedure is triggered to), such that the AMF assigns an appropriate AMF UE NGAP ID and associate the AMF UE NGAP ID with the context of this UE.

For the signaling transport network layer (TNL) association address at the source NG-C side, this IE indicates the AMF IP address associated with the SCTP used by the source NG-C interface instance. If there is no UE TNLA binding on the source NG-RAN node, the source NG-RAN node expresses that the source NG-RAN node will select the associated TNL address if the UE TNLA binding must be created.

For the UE security capability, this IE defines an encryption and integrity protection algorithm supported by the UE, and may include at least one of: an NR or E-UTRA encryption algorithm, an NR or E-UTRA integrity protection algorithm.

For the radio access technology (RAT)/frequency selection priority index (Index to RAT/Frequency Selection Priority), this IE is used to define a local configuration of a radio resource management policy, for example, a residence priority of the inter-radio access technology/inter-frequency mobility.

For the UE aggregate maximum bit rate, this IE is applicable to all UE-based Non-GBR QoS flows, including downlink and uplink directions, and the parameters of this subscription are provided by the AMF, and may include at least one of: a UE aggregate maximum bit rate downlink and a UE aggregate maximum bit rate uplink.

For the DL/UL tunnel information of each PDU session resource, this information may include at least one of: a packet data unit (PDU) session ID, a PDU session resource aggregate maximum bit rate, UL NG-U UP TNL information on a UPF, additional UL NG-U UP TNL information in a UPF list, redundant UL NG-U UP TNL information at the UPF, additional redundant UL NG-U UP TNL information in the UPF list, and source DL NG-U TNL information. Here, when this PDU session is provided with at least one Non-GBR QoS flow, there should be the IE (the PDU session resource aggregate maximum bit rate). The UL NG-U UP TNL information on the UPF is the information of a UPF endpoint of an NG-U transport bearer, for the transmission of the UL PDU. If the core network changes this information through the above path switch procedure, it is required to notify other candidate nodes through an LTM Configuration Update message, to indicate that the data transmission for the uplink NG-U TNL information can be performed in time when the UE accesses the candidate node.

The additional UL NG-U UP TNL information in the UPF list refers to an additional UPF endpoint of the NG-U transport bearer for the delivery of the UL PDU. The additional UL NG-U UP TNL information of the user plane (Additional UL NG-U UP TNL Information at UPF) includes one or more addresses.

The redundant UL NG-U UP TNL information at the UPF refers to the UPF endpoint of the NG-U transport bearer for the delivery of the UL PDU for the redundant transmission.

The additional redundant UL NG-U UP TNL information in the UPF list refers to an additional redundant UPF endpoint of the NG-U transport bearer for the delivery of the UL PDU. The additional UL NG-U UP TNL information of the user plane (Additional UL NG-U UP TNL Information at UPF) includes one or more addresses.

The source DL NG-U TNL information indicates a possibility that an NG-U GTP-U tunnel endpoint remains unchanged at the target NG-RAN node. If the current source node changes this information through the above path switch procedure, it is required to notify other candidate nodes through an LTM Configuration Update message, to indicate that the downlink NG-U TNL information is unchanged on the candidate node.

For the location reporting information, this IE includes a parameter on how the location information should be reported. The location reporting information may include at least one of: an event type, a report area, and area of interest information. Here, the event type is used to report a change in a serving cell, report the movement of the UE to or from an area of interest, . . . , and report a change in the serving cell and the area of interest. Report area=(Cell, . . . ). The area of interest information may include at least one of: a list of TAIs in the area of interest, a list of cells in the area of interest, a list of global NG-RAN nodes in the area of interest, and a request report reference ID.

For the mobility restriction list, this IE defines a roaming or access restriction for a subsequent mobile operation. For this reason, the NG-RAN provides information about a mobile operation target, e.g., a handover, or a selection for an SCG or an assignment for an appropriate wireless notification domain during a dual connectivity operation. If the NG-RAN receives the mobility restriction list IE, the NG-RAN will overwrite the previously received information.

For the management based MDT PLMN list, the purpose of this IE is to provide an MDT-allowed PLMN list.

For the UE radio capability ID, this IE includes UE capability ID information.

For the trace activation, this IE defines the parameter related to the trace activation.

For the version of blocked or protected international mobile equipment identity software (IMEISV), this IE includes a masked IMEISV value, to identify the terminal model without the need to identify a single mobile equipment.

For the UE history information, the UE History Information IE includes the information about a cell served by the UE in an active state before the target cell.

The mobility information refers to the information related to a handover. The source NG-RAN node provides the information in order to be able to later analyze the condition causing an erroneous handover in the future.

For the UE history information from the UE, this IE includes the information about a mobility history report of the UE, which may include a Visited Cell Information List (VisitedCellInfoList) IE of provided in a UE Information Response (UEInformationResponse) message.

For the time synchronization assistance information, this IE indicates a 5G access layer time distribution parameter.

For the to-be-released/cancelled LTM/candidate cell list (LTM/Candidate Cells To Be Released/Cancelled List), if, due to some reason of one or more candidate cells on the new source node (e.g., a cell overload), the source node now decides to cancel or release the candidate cells, the source node may notify other candidate nodes. The candidate cell cancel information may be transmitted through a separate message, for example, a Handover Cancel message, and needs to be transmitted after the LTM configuration update procedure is completed. If the candidate cell cancel information is transmitted through the LTM Configuration Update message at this time, the transmission for the handover cancel can be saved. The source node needs to reconfigure the UE through an RRC Reconfiguration message to release the resources of the cell, and the candidate node releases the resources of the indicated candidate cell after receiving the information. If the To-be-released/cancelled LTM/Candidate Cell List IE is included in the LTM Configuration Update message, the candidate or target NG-RAN node should consider that the source NG-RAN node only cancels the resource related to the candidate cell identified by the included NG-RAN CGI. If one or more LTM/candidate cells in the To-be-cancelled LTM/Candidate Cell List IE included in the LTM Configuration Update message are not prepared using the same UE-related signaling connection, the candidate or target NG-RAN node will ignore those unassociated LTM/candidate cells. The to-be-released/cancelled LTM/candidate cell list may include the ID of a cancelled or released LTM candidate cell (LTM/candidate/target cell ID), and the ID may be a cell ID, an NR CGI, or the like.

The access layer security information (AS Security Information) corresponding to one or more candidate cells on the candidate node may include one or more of: a candidate cell ID (e.g., the ID may be a cell ID or an NR CGI), an LTM configuration ID (corresponding to one candidate cell), a corresponding candidate cell, K_{NG-RAN}* (Key NG-RAN Star), and a next hop chaining counter (NCC). The K_{NG-RAN}* may be a key corresponding to candidate cell utilization and derived based on the NH parameter (obtained from the AMF) and the candidate cell information. The next hop chaining counter may be a new NCC value obtained from the AMF.

Upon receiving the LTM Configuration Update message, according to the specification of TS 33.501, the candidate or target NG-RAN node may prepare to configure the AS security relationship between a terminal and the target NG-RAN node for the LTM candidate cell by using the information in a Terminal Security Capability IE and an AS Security Information IE.

The access layer security information corresponding to each candidate cell may be transmitted to the candidate node to which the candidate cell belongs at different times by using the following schemes 1 and 2.

Scheme 1: Before the UE does not trigger a subsequent handover, the source node (new source node) derives a corresponding K_{NG-RAN}* by using a new NH parameter and the information of a corresponding candidate cell, and then transmits the corresponding K_{NG-RAN}* to the candidate node to which the candidate cell belongs in advance. If the candidate node has a secondary node (that is, dual connectivity is established for the UE), after obtaining the K_{NG-RAN}* information of the corresponding candidate cell, that is, a master node key, the candidate node derives a key S-K_{SN} used by the secondary node (S-NG-RAN node) through a secondary node key counter (SK-Counter, of which the value may be set to 0), and then notifies the secondary node (using an SN Modification Request message). In this way, after the UE performs the handover to access the target cell (one of the candidate cells), the target node can, in time, perform encryption processing on downlink forwarding data to transmit the data to the UE, and may, in time, decrypt the uplink data of the UE for further processing. Since the security information has been acquired in advance, the data transmission of the UE is not affected, thereby avoiding the data forwarding delay or the processing delay due to the fact that the security information of the target cell is not obtained in the data transmission process. However, there may be a situation where resources are wasted due to the failure to utilize the security information of the candidate cell that the UE does not access in this round of handover.
Scheme 2: When the UE decides to trigger a handover (LTM), the source node derives, only for the target cell, a corresponding access layer security information K_{NG-RAN}* by using a new NH parameter and the information of the target cell. The ID information of the target cell and the corresponding K_{NG-RAN}* are carried in a Cell Switch Notification message transmitted by the source node, to be transmitted to the target node, for example, through the Cell Switch Notification in operation 404a when the subsequent handover is triggered. If the candidate node has a secondary node (that is, dual connectivity is established for the UE), after obtaining the KNG-RAN* information of the corresponding target cell, that is, a master node key, the target node derives a key S-K_{SN} used by the secondary node (S-NG-RAN node) through a secondary node key counter (SK-Counter, of which the value may be set to 0), and then notifies the secondary node (using an SN Modification Request message). In this way, the signaling can be saved, and the security information can be derived and utilized only for the target cell. However, for the handover of an LTM type, with respect to the L1 measurement result of the UE, the source node or the gNB-DU of the source node transmits a cell switch command to the UE, and the UE may quickly access the target cell through a rach-less access for data reception and transmission. However, due to a large transmission delay between the network nodes, the time at which the Cell Switch Notification message is transmitted from the source node or the gNB-DU of the source node to the target node may be later than the time at which the UE successfully accesses the target cell. As a result, the target node needs to wait to receive the security information, and then can perform encryption processing on the downlink forwarding data to transmit the encrypted data to the UE, and the UE needs to wait to receive the security information, and then can perform decryption to further process the uplink data.

Optionally, in operation 411, the one or more pieces of information carried in the LTM Configuration Update message may be transmitted in advance from the new source node to each other candidate node through the LTM Configuration Update message in operation 411. However, this may waste the signaling. For a target node that the UE does not access, after a handover, if the UE does not access this candidate node, these information will be overwritten by the one or more pieces of information carried in the LTM Configuration Update message initiated by the new source node. Therefore, alternatively, the one or more pieces of information included in the LTM Configuration Update message in the above operation 411 may also be carried by the Cell Switch Notification message in operation 404a when the next handover is triggered, and the new source node only transmits the information to the target node when the subsequent handover is triggered. In this way, there may be a situation where resources are wasted due to the failure to utilize the security information of the candidate cell that the UE does not access in this round of handover. In this way, it is possible to avoid the situation where the information is wasted on the node not accessed by the UE when the new source node transmits these information to each other candidate node in advance in the above procedure.

In operation 411, the LTM Configuration Update message (or other message) may be transmitted based on each node (per-node) or each cell (per-cell). For the per-node transmitting, signaling can be saved. If there are a plurality of candidate cells on the candidate node, the LTM Configuration Update message may carry the ID information of each candidate cell (e.g., the ID may be a cell ID or an NR CGI) and/or the LTM configuration ID information corresponding to each candidate cell. Moreover, the K_{NG-RAN}* is associated with a candidate cell, and corresponding candidate cell information may be indicated to each K_{NG-RAN}*.

As an example, the cell information includes source cell information and/or candidate cell information.

If the LTM Configuration Update message (or other message) is transmitted based on each cell, the cell information may contain one or more of: a source cell ID, a candidate cell ID and/or an LTM configuration ID, and a source cell ID-candidate cell ID pair. Here, the source cell ID refers to the ID of the cell serving the current UE, that is, the ID of the candidate cell accessed by the UE (e.g., the ID may be a cell ID or an NR CGI) and/or the LTM configuration ID. The candidate cell ID and/or the LTM configuration ID correspond to one LTM candidate cell.

If the LTM Configuration Update message (or other message) is transmitted based on each node, the cell information may include one or more of: one or more cell IDs, a candidate cell ID, and a source cell ID-candidate cell ID pair. Here, the one or more cell IDs refer to the ID of the candidate cell accessed by the UE (i.e., the ID of the cell currently serving the UE) and other candidate cells on the serving node (e.g., the ID may be a cell ID, an NR CGI and/or an LTM configuration ID).

In operation 412, transmitting, by the candidate node, an SN Modification Request message to a candidate secondary node if the candidate secondary node is configured.

Optionally, the SN Modification Request message may be another message, and the SN Modification Request message may carry one or more of: a source MN node ID or a source node ID (Source NG-RAN node ID), a source SN node ID (Source S-NG-RAN node ID), data forwarding proposal information, an LTM modification or update indication, and access layer security information used by a candidate PSCell on the candidate secondary node.

For example, for the source MN node ID or the source node ID (Source NG-RAN node ID), by carrying this IE, it is possible to query, from the candidate secondary node, whether there is a direct forwarding path with the source node or the source MN node. After receiving this information, the candidate secondary node determines whether there is the direct forwarding path between the candidate secondary node and the source master node or the source node, and then returns the result to the candidate master node. If the Source NG-RAN Node ID IE is included in the S-NODE Modification Request message, and if supported, the S-NG-RAN node should use the ID IE to determine the availability of the direct data path with a specified source NG-RAN node. If the direct data forwarding path is available, a Direct Forwarding Path Availability IE set to “direct path available” is included in an S-NODE Modification Request Acknowledge message, and thus, the direct early data forwarding can be realized, thereby saving forwarding resources.

For example, for the source SN node ID (Source S-NG-RAN node ID), by carrying this IE, it is possible to query, from the candidate secondary node, whether there is a direct forwarding path with the source SN node. After receiving this information, the candidate secondary node determines whether there is the direct forwarding path between the candidate secondary node and the source secondary node, and then returns the result to the candidate master node. If the Source S-NG-RAN Node ID IE is included in the S-NODE Modification Request message, and if supported, the S-NG-RAN node should use the ID IE to determine the availability of the direct data path with a specified source S-NG-RAN node. If the direct data forwarding path is available, a Direct Forwarding Path Availability IE set to “direct path available” is included in an S-NODE Modification Request Acknowledge message, and thus, the direct early data forwarding can be realized, thereby saving forwarding resources.

For example, for the data forwarding proposal information, this information may be represented by a Data Forwarding and Offloading Information information element from the source gNB (Data Forwarding and Offloading Info IE from source NG-RAN node), and a data forwarding proposal may be requested based on the PDU session corresponding to a PDU session ID (the PDU session may be represented by the PDU session ID) and/or a quality of service (QoS) flow (which may be represented by a QoS flow ID).

For example, the LTM modification or update indication (e.g., an LTM indication, of which the value may be “modification” or “update”), or an LTM modification or update request.

For example, the access layer security information used by the candidate PSCell on the candidate secondary node is a secondary node (S-NG-RAN node) security key S-K_{SN}.

In operation 413, returning, by the candidate secondary node, an SN Modification Request Acknowledge message to the candidate master node.

Optionally, the SN Modification Request Acknowledge message may be another message, and the SN Modification Request Acknowledge message may carry one or more of: the direct forwarding path availability information between the candidate secondary node and the source node or the source MN node, the direct forwarding path availability information between the candidate secondary node and the source SN node, and a data forwarding address.

Here, for the direct forwarding path availability information between the candidate secondary node and the source node or the source MN node (Direct Forwarding Path Availability with source (M-)NG-RAN node) (e.g., the SN3 and GNB2/MN2 in FIGS. 4A and 4B), after receiving the source MN node ID or source node ID information, the candidate secondary node determines whether there is the direct forwarding path between the candidate secondary node and the source master node or the source node, and then returns the result to the candidate master node. Thus, the direct early data forwarding can be realized, thereby saving forwarding resources.

For the direct forwarding path availability information between the candidate secondary node and the source SN node (Direct Forwarding Path Availability with source S-NG-RAN node) (e.g., the SN3 and SN2 in FIGS. 4A and 4B), after receiving the source SN node ID information, the candidate secondary node determines whether there is the direct forwarding path between the candidate secondary node and the source secondary node, and then returns the result to the candidate master node. Thus, the direct early data forwarding can be realized, thereby saving forwarding resources.

In an embodiment of the disclosure, the direct forwarding path availability information may directly and explicitly indicate that the direct forwarding path is available or unavailable. Alternatively, in another embodiment, the direct forwarding path availability information may only indicate that the direct forwarding path is available, and accordingly, when the IE corresponding to the direct forwarding path availability information does not exist, it may be implicitly indicated that the direct forwarding path is unavailable. Alternatively, in another embodiment, the direct forwarding path availability information may only indicate that the direct forwarding path is unavailable, and accordingly, when the IE corresponding to the direct forwarding path availability information does not exist, it may be implicitly indicated that the direct forwarding path is available.

The data forwarding address may be represented by the Data Forwarding Information IE (Data Forwarding Info from Candidate/Target NG-RAN Node IE) from the candidate/target node. The data forwarding address may be configured based on the established PDU session ID or QoS flow ID or DRB ID on the candidate secondary node. The data forwarding address may include one or more of: a packet data unit session ID (identifier, PDU session ID), the established QoS flow ID information accepted under the PDU session ID corresponding to a quality of service flow ID (QoS flow ID), the data forwarding address corresponding to a QoS flow under an established PDU session (e.g., the downlink/uplink data forwarding user plane tunnel information of the PDU session (PDU session level DL/UL data forwarding UP TNL information)), a data radio bearer ID (DRB ID), and the data forwarding address corresponding to the QoS flow under the established PDU session and mapped to a DRB (i.e., DL forwarding UP TNL information, downlink forwarding user plane tunnel information).

In operation 414, returning, by the candidate master node, an LTM Configuration Update Acknowledge message to the candidate source node.

Optionally, the LTM Configuration Update Acknowledge message may be another message, and the LTM Configuration Update Acknowledge message may carry one or more of: the UE XnAP ID (Source NG-RAN node UE XnAP ID) assigned by the new source node currently serving the UE, a UE XnAP ID (Target NG-RAN node UE XnAP ID) assigned by a current candidate node, the direct forwarding path availability information between the candidate master node or the candidate node and the source SN node, a data forwarding address, a to-be-released/to-be-cancelled LTM/candidate cell list, and cell information. Here,

For the UE XnAP ID assigned by the current candidate node, after receiving Last Serving NG-RAN node UE XnAP ID information (i.e., the UE XnAP ID assigned by the NG-RAN node last serving the UE), the candidate node can identify a UE (which UE the configuration update procedure is performed on), and then the candidate node assigns an appropriate UE XnAP ID to the UE on the Xn interface between the current source node and this candidate node. Optionally, it is possible to assign a UE XnAP ID identical to the UE XnAP ID assigned during the handover request procedure or the LTM configuration update procedure occurring at the Xn interface between the last source node and this candidate node, and the UE XnAP ID is associated with the context of the UE on the Xn interface.

For the direct forwarding path availability information between the candidate master node or the candidate node and the source SN node (e.g., the MN3/gNB3 and SN2 in the drawing), this information may be indicated based on the PDU session ID, and may be included in the Data Forwarding Information IE from the candidate/target node (Data Forwarding Info from candidate/target NG-RAN node IE), and indicated based on the PDU session ID. The PDCP of some PDU session is positioned at the candidate master node, and the PDCP of some PDU session is positioned at the candidate secondary node. Therefore, for a PDU session having a PDCP positioned at the candidate SN, if the candidate master node learns, through the above procedure operations 412 and 413, that there is a direct forwarding path between the candidate SN and the source MN or the source SN, the candidate master node forwards, from the candidate secondary node, the data forwarding address assigned to this PDU session to the source node. If the received PDU session is a PDU session mapped from the source SN to the candidate MN or the candidate SN, the source MN forwards the data forwarding address received from the candidate MN to the source SN, to enable the data of this PDU session to be directly forwarded from the source SN to the candidate MN or the candidate SN.

The data forwarding address may be represented by the Data Forwarding Information IE from the candidate/target node. The data forwarding address may be configured based on the established PDU session ID or QoS flow ID or DRB ID on the candidate node or the candidate master node and the secondary node. Moreover, for the PDU session/QoS/DRB established on the candidate secondary node, if there is a direct forwarding path between the candidate secondary node and the source node, the source master node or the source secondary node, the candidate master node transmits, to the source node or the source master node, the data forwarding address assigned by the candidate secondary node. The data forwarding address may include one or more of: a packet data unit session ID (identifier, PDU session ID), the established QoS flow ID information accepted under the PDU session ID corresponding to a quality of service flow ID (QoS flow ID), the data forwarding address corresponding to a QoS flow under an established PDU session (e.g., PDU session level downlink/uplink data forwarding user plane tunnel information), a data radio bearer ID (DRB ID), the data forwarding address corresponding to the QoS flow under the established PDU session and mapped to a DRB (i.e., DL forwarding UP TNL information, downlink forwarding user plane tunnel information), and a candidate cell ID (e.g., the ID may be a cell ID or an NR CGI).

For the data forwarding addresses corresponding to different candidate cells on this node, the data forwarding addresses that may be assigned to different candidate cells are different. In this case, each data forwarding address may indicate corresponding candidate cell ID information. A data forwarding address may be represented by the Data Forwarding Information IE from the candidate/target node.

The LTM Configuration Update Acknowledge message is a corresponding reply based on whether the LTM Configuration Update message is transmitted based on each node or each cell. If the LTM Configuration Update message is transmitted based on each node, the LTM Configuration Update Acknowledge message will also be returned based on each node. If there are a plurality of candidate cells on the candidate node, and if the information carried in the LTM Configuration Update Acknowledge message is associated with a candidate cell, the information may indicate the ID information of the corresponding candidate cell (e.g., the ID may be a cell ID or an NR CGI) and/or the LTM configuration ID information corresponding to the candidate cell. For example, if the data forwarding address is associated with a candidate cell, the corresponding candidate cell information may be indicated to each data forwarding address.

For the to-be-released/cancelled LTM/candidate cell list, if, due to some reason of one or more candidate cells on the candidate node (e.g., a cell overload), the candidate node now decides to cancel or release the candidate cells, the candidate node may notify the current source node. The candidate cell cancel information may be transmitted through a separate message, for example, an LTM Cancel message, and needs to be transmitted after the LTM configuration update procedure is completed. If the candidate cell cancel information is transmitted through the LTM Configuration Update Acknowledge message at this time, the transmission for the LTM Cancel message can be saved. After receiving this information, the source node releases the resource information of the indicated candidate cell, notifies other candidate nodes of the released cell information through the LTM Configuration Update or Handover Cancel message, and reconfigures the UE through an RRC Reconfiguration message to release the resources of the cell. If the To-be-released/cancelled LTM/Candidate Cell List IE is included in the LTM Configuration Update Acknowledge message, the source NG-RAN node only releases the resource related to the candidate cell identified by the included NG-RAN CGI. If one or more LTM/candidate cells in the To-be-cancelled LTM/Candidate Cell List IE included in the LTM Configuration Update Acknowledge message are not prepared using the same UE-related signaling connection, the source NG-RAN node will ignore those unassociated LTM/candidate cells. The to-be-released/cancelled LTM/candidate cell list may include the ID of a cancelled or released LTM candidate cell (LTM/candidate/target cell ID), and the ID may be a cell ID, an NR CGI, or the like.

The cell information includes source cell information and/or candidate cell information.

If the LTM Configuration Update Acknowledge message is transmitted based on each cell, the cell information may include one or more of: a source cell ID, a candidate cell ID and/or an LTM configuration ID, and a source cell ID-candidate cell ID pair. Here, the source cell ID refers to the ID of the cell serving the current UE (i.e., the ID of the candidate cell accessed by the UE (e.g., the ID may be a cell ID or an NR CGI)) and/or the LTM configuration ID, the candidate cell ID and/or the LTM configuration ID corresponding to one LTM candidate cell.

If the LTM Configuration Update Acknowledge message is transmitted based on each node, the cell information may include one or more of: one or more cell IDs, a candidate cell ID, and a source cell ID-candidate cell ID pair. Here, the one or more cell IDs refer to the ID of the candidate cell accessed by the UE (i.e., the ID of the cell currently serving the UE) and/or other candidate cells on the serving node (e.g., the ID may be a cell ID, an NR CGI and/or an LTM configuration ID).

In operation 415, notifying, by the source MN, the source SN of a data forwarding address of a corresponding PDU session through an Xn-U address indication or another XnAP message.

Optionally, if a certain PDU session is a PDU session mapped from the source SN to the candidate MN or the candidate SN, the source MN forwards the data forwarding address received from the candidate MN to the source SN when learning there is a direct forwarding path, to enable the data of this PDU session to be directly forwarded from the source SN to the candidate MN or the candidate SN.

In operations 411-414 and operations 412-413 may be optional. For example, if the UE is configured in single connectivity with only a candidate node (the GBN3/MN3 in FIGS. 4A and 4B) without including a candidate secondary node (the SN3 in FIGS. 4A and 4B), operations 411 and 414 will be performed, and operations 412-413 may not be performed.

In operation 416, alternatively, after a successful handover of the UE to the target node, enabling to trigger a UE context release procedure if the source node is not used as a candidate node for a subsequent handover.

For example, after the UE successfully switches to the target node GNB2/MN2, if there is no candidate cell on the source node GNB1, the UE context release procedure may be triggered.

In the above operations 401-416, after successfully performing the initial handover, the UE proceeds to the next or next round of handover preparation process, as follows:

In operation 401a, for the next round of handover, the source node obtains the data forwarding address of each candidate node (including the master node and/or the secondary node) and information on whether there is a direct forwarding path through the above procedures, and may notify the source secondary node of the data forwarding address of the related PDU session/QoS flow/DRB through a message, and thus, the source node or the source master node and the source secondary node may trigger an early data forwarding procedure.

With the movement of the UE, the UE may be triggered by a new source node for the next handover, and the subsequent operations 402a-414a are similar to the above operations 402-414, and thus the details will not be repeatedly described here.

As an example, the scenarios of the inter-node handover of the UE may include: the handover from the source NG-RAN node to the target NG-RAN node, the handover from the source NG-RAN node to the target MN+SN, the handover from the source MN+SN to the target MN+SN (SN unchanged), the handover from the source MN+SN to the target MN+SN (SN changed), and the handover from the source MN+SN to the target NG-RAN node.

After the UE performs the handover each time, the target node may assign corresponding UE XnAP IDs to the new source node and other candidate nodes through the LTM configuration update procedure to associate with the corresponding UE. The above embodiment is a scheme for the UE in the LTM procedure, but the scheme is still applicable to other handover scenarios, for example, the scenarios of the handover of the UE between the above nodes such as an L3 handover and a CHO.

The first to fifth nodes in the disclosure may be one of the following types (not rule out other types of devices that user equipment may access): a long term evolution (LTE) base station, a 5G base station, a 6G base station, a RAN node, a non-terrestrial networks (NTN) base station, a high altitude platform station (HAPS) base station, a drone base station, a WIFI access point, a base station, or the central unit of a base station, the control plane of the central unit of the base station, or the like.

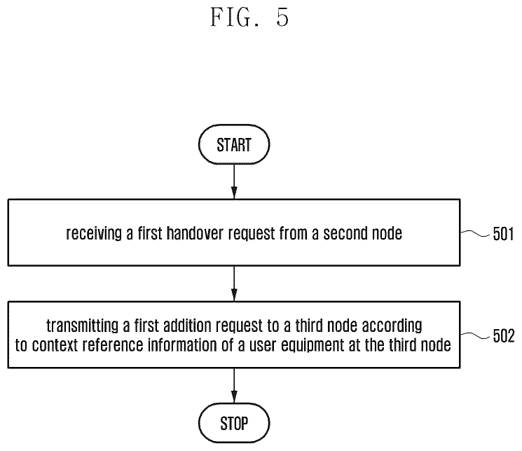

FIG. 5 illustrates a method performed by a first node in a wireless communication system according to an embodiment of the disclosure. The method is suitable for being performed by the GNB3/MN3 described in FIGS. 3, 4A, and 4B. According to the embodiment, the method performed by the first node in the wireless communication system comprises the following operations:

In operation 501, receiving a first handover request from a second node, the first handover request comprising context reference information of a user equipment at a third node.

The first node is a candidate node of the second node, a second handover request is transmitted by the second node, a second handover response is transmitted by a fourth node, and the second handover response comprises the context reference information of the user equipment at the third node. Here, the context reference information of the user equipment at the third node comprises an identifier of the third node and an identifier assigned by the third node to the user equipment, and the third node is a secondary node of the fourth node.

In an embodiment of the disclosure, the first node may be the other candidate node GNB3/MN3 described in FIGS. 3, 4A, and 4B, the second node may be the source master node or the source node GNB1/MN1 described in FIGS. 3, 4A, and 4B, the third node may be the other candidate node or the source SN node SN2 described in FIGS. 3, 4A, and 4B, the fourth node may be the candidate master node or the new source node GNB2/MN2 described in FIGS. 3, 4A, and 4B, and the fifth node may be the candidate secondary node SN3 described in FIGS. 4A and 4B.

Optionally, for a specific implementation of the reception of the first handover request by the first node in operation 501, reference may be made to operation 305. For an implementation of the first handover request, reference may be made to the implementation of the second request message in operation 305.

In operation 502, transmitting a first addition request to the third node according to the context reference information of the user equipment at the third node, the first addition request comprising a request for an addition of the third node as a secondary node to establish dual connectivity for the user equipment.

Optionally, for a specific implementation of the transmitting of the first addition request in operation 502, reference may be made to operation 306. For an implementation of the first addition request, reference may be made to the implementation of the SN Addition Request message in operation 306.

In some embodiments, the context reference information of the user equipment at the third node may comprise at least one of: an identifier of the third node and an identifier assigned by the third node to the user equipment.

As an example, for a specific implementation of the context reference information of the user equipment at the third node, reference may be made to the specific implementation of the context reference information of the UE at the candidate secondary node in the method shown in FIG. 3. For example, the identifier assigned by the third node to the user equipment may be a UE XnAP ID assigned by the third node to the UE.

In some embodiments, the method may further comprise: receiving a first addition response from the third node. The first addition response may comprise information related to an acknowledgement of the third node as the secondary node to establish the dual connectivity for the user equipment. The method may further comprise: transmitting a first handover response to the second node. The first handover response may comprise: information related to the addition of the third node as the secondary node.

As an example, for a specific implementation of the reception of the first addition response by the first node, reference may be made to the specific implementation in operation 307. For a specific implementation of the first addition response, reference may be made to the specific implementation of the SN Addition Request Acknowledge message in operation 307. For a specific implementation of the transmitting of the first handover response by the first node, reference may be made to the specific implementation in operation 308. For a specific implementation of the first handover response, reference may be made to the specific implementation of the second acknowledge message in operation 308.

In some embodiments, the first addition request may further comprise first identifier information of the user equipment, the first addition response may further comprise resource configuration information of the user equipment at a candidate cell on the third node, and the first handover response may further comprise the resource configuration information of the user equipment at the candidate cell on the third node.

Optionally, the resource configuration information is determined based on the first identifier information and a first rule, and the first rule may comprise: configuring identical resources for the same user equipment at the same candidate cell.

In some embodiments, the first handover request may further comprise at least one of: an identifier of the fourth node and an identifier assigned by the fourth node to the user equipment. The first identifier information may comprise at least one of: an identifier of the second node, an identifier assigned by the second node to the user equipment, the identifier of the third node, the identifier assigned by the third node to the user equipment, the identifier of the fourth node, and the identifier assigned by the fourth node to the user equipment.

Optionally, for a specific implementation of the first identifier information of the user equipment, reference may be made to the specific implementation of the identifier of the user equipment in the SN Addition Request message in operation 306.

In some embodiments, the method may further comprise: receiving a first message from the fourth node. The first message may comprise at least one of: information for requesting a direct forwarding path, information for requesting a data forwarding address, and the identifier assigned by the second node to the user equipment. The method may further comprise: transmitting a second message to the fourth node. The second message may comprise at least one of: first information related to the direct forwarding path, first address information related to the data forwarding address, and an identifier assigned by the first node to the user equipment. The normal data forwarding is implemented.

As an example, after the handover of the user equipment from accessing to the second node to accessing to the fourth node, the first node receives the first message and transmits the second message. The target node accessed by the UE transmits a request, and the node not accessed by the UE does not need to transmit a request, which can avoid wasting the previously acquired information, thereby reducing the signaling overhead.

Optionally, the first message may be an LTM Configuration Update message or a Cell Switch Notification message. The second message may be an LTM Configuration Update Acknowledge message. For a specific implementation of the first message, reference may be made to the description of the LTM Configuration Update message or the Cell Switch Notification message in FIGS. 4A and 4B, and for a specific implementation of the second message, reference may be made to the description of the LTM Configuration Update Acknowledge message in FIGS. 4A and 4B, and thus the details will not be repeatedly described here.

In some embodiments, the information for requesting the direct forwarding path may comprise at least one of: the identifier of the fourth node and the identifier of the third node.

For example, in combination with FIGS. 4A and 4B, the identifier of the fourth node is the ID of the source node currently serving the UE, and the identifier of the third node is the ID of the source SN node.

The information for requesting the direct forwarding path may be used to explicitly indicate a request on whether there is a direct forwarding path between the first node and the fourth node and/or the third node in this information (the information for requesting the direct forwarding path). The information carrying at least one of the identifier of the fourth node and the identifier of the third node (the information for requesting the direct forwarding path) may also implicitly indicate a request, from the first node, on whether there is a direct forwarding path between the first node and the fourth node and/or the third node. The first node replies to the second node after determining the information on whether there is the direct forwarding path.

Optionally, for a specific implementation of the information for requesting the data forwarding address, reference may be made to the description of the data forwarding proposal information in the method (e.g., operation 411) shown in FIGS. 4A and 4B, and thus the details will not be repeatedly described here.

In some embodiments, the first information may comprise: information on whether there is a direct forwarding path between the first node and the third node based on a packet data unit session.

For example, for a specific implementation of the first information, reference may be made to the specific implementation of the direct forwarding path availability information between the candidate master node or the candidate node and the source SN node in the method (e.g., operation 411) shown in FIGS. 4A and 4B. For example, in combination with FIGS. 4A and 4B, the fifth node may be the SN3.

In some embodiments, the first address information may comprise at least one of: a packet data unit session or data radio bearer-based data forwarding address between the first node and the third node; a packet data unit session or data radio bearer-based data forwarding address between the fifth node and the fourth node; and a packet data unit session or data radio bearer-based data forwarding address between the fifth node and the third node. Here, the fifth node is a secondary node of the first node.

For example, for a specific implementation of the first address information, reference may be made to the specific implementation of the data forwarding address in the method (e.g., operation 414) shown in FIGS. 4A and 4B.

In some embodiments, the first message may further comprise context reference information of the user equipment at the second node. Optionally, the method may further comprise: performing context association on the user equipment according to the context reference information of the user equipment at the second node. For a specific implementation of the context reference information, reference may be made to the specific implementation of the UE context reference information of the NG-RAN node last serving the UE in the method (e.g., operation 411) shown in FIGS. 4A and 4B.

In some embodiments, the first message may further comprise notification information for releasing a resource of a candidate cell on the fourth node, and the notification information may comprise identifier information of a to-be-released candidate cell on the fourth node. Optionally, the method may further comprise: releasing the resource of the candidate cell identified by the identifier information in the notification information. For example, for a specific implementation of the identifier information of the to-be-released candidate cell on the fourth node, reference may be made to the specific implementation of the to-be-released/to-be-cancelled LTM/candidate cell list in the method (e.g., operation 411) shown in FIGS. 4A and 4B.

In some embodiments, the method may further comprise: receiving access layer security information of a candidate cell on the first node from the fourth node. Here, the access layer security information is received through a Layer 1 or Layer 2 Triggered Mobility (LTM) Configuration Update message, or received through a Cell Switch Notification message. For a specific scheme in which the first node obtains the security information, reference may be made to the schemes 1 and 2 described in the method (e.g., operation 411) shown in FIGS. 4A and 4B.

In some embodiments, the method may further comprise: determining information related to access layer security information of a candidate cell on the fifth node, according to security information related to the access layer security information of the candidate cell on the first node. The fifth node is the secondary node of the first node.

In some embodiments, the access layer security information of the candidate cell on the first node may comprise at least one of: an identifier of the candidate cell on the first node, an LTM configuration identifier, a key of the candidate cell, and a next hop chaining counter.

For example, for a specific implementation of the access layer security information of the candidate cell on the first node, reference may be made to the specific implementation of the access layer security information corresponding to one or more candidate cells on the candidate node in the method (e.g., operation 411) shown in FIGS. 4A and 4B.

In some embodiments, the first message may further comprise at least one of: a globally unique access and mobility management function (AMF) identifier; a user equipment next generation application layer protocol identifier assigned by an access and mobility management function (AMF) network element; and downlink or uplink tunnel information of each packet data unit session resource. For example, for a specific implementation of the globally unique access and mobility management function (AMF) identifier, reference may be made to the description of the GUAMI in the method (e.g., operation 411) shown in FIGS. 4A and 4B. For a specific implementation of the user equipment next generation application layer protocol identifier assigned by the AMF network element, reference may be made to the description of the NG-C UE associated signaling reference in the method (e.g., operation 411) shown in FIGS. 4A and 4B. For example, the user equipment next generation application layer protocol identifier assigned by the AMF network element is the identifier of the UE on the interface of the base station and the core network. For the downlink or uplink tunnel information of each packet data unit session resource, reference may be made to the corresponding description in the method (e.g., operation 411) shown in FIGS. 4A and 4B.

In some embodiments, the second message may further comprise: information for releasing a resource of a candidate cell on the first node. For example, for a specific implementation of the information for the notification of the release for the resource of the candidate cell on the first node, reference may be made to the description of the to-be-released/to-be-cancelled LTM/candidate cell list in the method (e.g., operation 411) shown in FIGS. 4A and 4B.

In some embodiments, the method may further comprise: transmitting a third message to the fifth node. The third message may comprise at least one of: information for requesting a direct forwarding path, and information for requesting a data forwarding address. The method may further comprise: receiving a fourth message from the fifth node. The fourth message may comprise at least one of: second information related to the direct forwarding path, and second address information related to the data forwarding address.

Optionally, the third message may be an SN Modification Request message. The fourth message may be an SN Modification Request Acknowledge message. For a specific implementation of the third message, reference may be made to the description of the SN Modification Request message in FIGS. 4A and 4B (e.g., operation 412), and thus the details will not be repeatedly described here. For a specific implementation of the fourth message, reference may be made to the description of the SN Modification Request Acknowledge message in FIGS. 4A and 4B (e.g., operation 413), and thus the details will not be repeatedly described here.

Optionally, the information for requesting the direct forwarding path may comprise at least one of: the identifier of the fourth node and the identifier of the third node.

For example, for a specific implementation of the information for requesting the data forwarding address, reference may be made to the description of the data forwarding proposal information in FIGS. 4A and 4B (e.g., operation 412).

The information for requesting the direct forwarding path in the third message may be used to explicitly indicate a request on whether there is a direct forwarding path between the fifth node and the fourth node and/or the third node in this information (the information for requesting the direct forwarding path). The information carrying at least one of the identifier of the fourth node and the identifier of the third node (the information for requesting the direct forwarding path) may also implicitly indicate a request, from the fifth node, on whether there is the direct forwarding path between the fifth node and the fourth node and/or the third node. The fifth node replies to the first node after determining the information on whether there is the direct forwarding path.

In some embodiments, the second information may comprise at least one of: information on whether there is a direct forwarding path between the fifth node and the fourth node, and information on whether there is a direct forwarding path between the fifth node and the third node.

For example, for a specific implementation of the second information related to the direct forwarding path, reference may be made to the description of the direct forwarding path availability information between the candidate secondary node and the source node or the source MN node and the description of the direct forwarding path availability information between the candidate secondary node and the source SN node in FIGS. 4A and 4B (e.g., operation 413).

In some embodiments, the second address information may comprise at least one of: the packet data unit session or data radio bearer-based data forwarding address between the fifth node and the fourth node, and the packet data unit session or data radio bearer-based data forwarding address between the fifth node and the third node. Here, the fifth node is a secondary node of the first node.

For example, for a specific implementation of the second address information related to the data forwarding address, reference may be made to the description of the data forwarding address in FIGS. 4A and 4B (e.g., operation 413).

In some embodiments, the third message may further comprise the information related to the access layer security information of the candidate cell on the fifth node. For a specific implementation of the information, reference may be made to the description of the access layer security information used by the candidate PSCell on the candidate secondary node in FIGS. 4A and 4B (e.g., operation 412).

Optionally, the first node may perform any of the operations performed by the GNB3/MN3 in the methods shown in FIGS. 3, 4A, and 4B, and accordingly, reference may be respectively made to the related descriptions of the operations in the above embodiments, and thus the details will not be repeatedly described here.

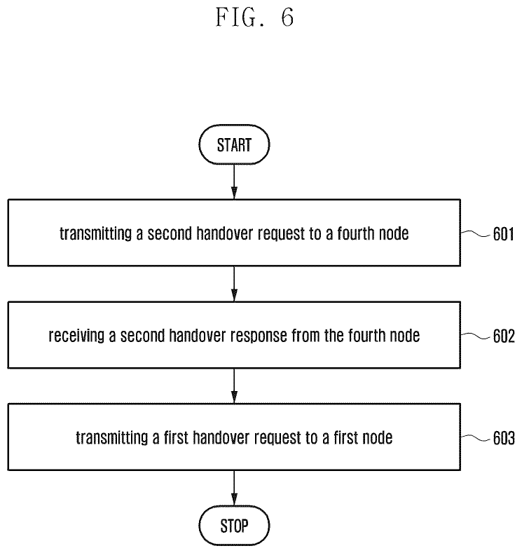

FIG. 6 illustrates a method performed by a second node in a wireless communication system according to an embodiment of the disclosure. The method is suitable for being performed by the GNB1/MN1 described in FIGS. 3, 4A, and 4B. According to the embodiment, the method performed by the second node in the wireless communication system comprises the following operations:

In operation 601, transmitting a second handover request to a fourth node.

In operation 602, receiving a second handover response from the fourth node. The second handover response comprises context reference information of a user equipment at a third node. Here, the context reference information of the user equipment at the third node comprises an identifier of the third node and an identifier assigned by the third node to the user equipment, and the third node is a secondary node of the fourth node.

Optionally, for a specific implementation of the transmitting of the second handover request by the second node, reference may be made to the specific implementation of the transmitting of the first request message in operation 301. For an implementation of the second handover response, reference may be made to the implementation of the first acknowledge message in operation 304.

In some embodiments, the context reference information of the user equipment at the third node may comprise at least one of: the identifier of the third node and the identifier assigned by the third node to the user equipment.

When the fourth node replies to the second node, the ID of the third node and/or the identifier assigned by the third node to the user equipment (i.e., the ID of a secondary node (S-NG-RAN node) and/or the UE XnAP ID identifier information (S-NG-RAN node UE XnAP ID) assigned by the secondary node) are carried. The second node is expected to notify other candidate master nodes to continue configuring the secondary node currently configured for the user equipment as the secondary node for the user equipment to save the resource assignment and utilization. When the second node transmits the handover request to the other candidate master nodes, the ID of the third node and/or the identifier assigned by the third node to the user equipment are carried, and accordingly, the candidate master nodes are expected to continue to configure the third node for the user equipment.

In operation 603, transmitting a first handover request to a first node, the first handover request comprising the context reference information of the user equipment at the third node. The first node is a candidate node of the second node.

Optionally, for a specific implementation for transmitting the first handover request by the second node in operation 603, reference may be made to operation 503. For an implementation of the first handover request, reference may be made to the implementation of the second request message in operation 305.

In some embodiments, the method may further comprise: receiving a first handover response from the first node. The first handover response may comprise information related to the addition of the third node as the secondary node.

For a specific implementation in which the second node receives the first handover response from the first node, reference may be made to the specific implementation in operation 308. For a specific implementation of the first handover response, reference may be made to the specific implementation of the second acknowledge message in operation 308.

In some embodiments, the second handover response may further comprise resource configuration information of the user equipment at a candidate cell on the third node. For a specific implementation of the resource configuration information of the user equipment at the candidate cell on the third node, reference may be made to the specific implementation of the resource configuration information of the candidate cell configured for the UE and obtained in operation 303.

In some embodiments, the second addition request is transmitted by the fourth node, and the second addition request is used to request an addition of the third node as a secondary node to establish dual connectivity for the user equipment. The second addition response is transmitted by the third node, and the second addition response comprises information related to an acknowledgement of the third node as the secondary node to establish the dual connectivity for the user equipment.

Optionally, the second addition request may comprise second identifier information of the user equipment, and the second identifier information may comprise at least one of: an identifier of the second node and an identifier assigned by the second node to the user equipment. The second addition response may further comprise the resource configuration information of the user equipment at the candidate cell on the third node.

For a specific implementation in which the third node receives the second addition request from the fourth node, reference may be made to operation 302. For a specific implementation of the second addition request, reference may be made to the specific implementation of the SN Addition Request message in operation 302. For the second identifier information of the user equipment, reference may be made to the identifier of the user equipment in the above SN Addition Request message. For a specific implementation of the transmitting of the second addition response to the fourth node, reference may be made to operation 303, and for a specific implementation of the second addition response, reference may be made to the specific implementation of the SN Addition Request Acknowledge message in operation 303.

In some embodiments, the first addition request may comprise first identifier information of the user equipment. The method may further comprise: determining resource configuration information of the user equipment at the candidate cell on the third node according to the first identifier information and a first rule. The first rule may comprise configuring identical resources for the same user equipment at the same candidate cell, and the first addition response may further comprise the resource configuration information of the user equipment at the candidate cell on the third node.

In some embodiments, the user equipment switches from accessing to the second node to accessing to the fourth node. A first message is transmitted by the fourth node to the first node, and the first message may comprise at least one of: information for requesting a direct forwarding path, information for requesting a data forwarding address, and an identifier assigned by the second node to the user equipment. A second message is transmitted by the first node to the fourth node, and the second message may comprise at least one of: first information related to the direct forwarding path, first address information related to the data forwarding address, and an identifier assigned by the first node to the user equipment.

In some embodiments, the information for requesting the direct forwarding path may comprise at least one of: an identifier of the fourth node and the identifier of the third node.

In some embodiments, the first information may comprise information on whether there is a direct forwarding path between the first node and the third node based on a packet data unit session.

In some embodiments, the first address information may comprise at least one of: a packet data unit session or data radio bearer-based data forwarding address between the first node and the third node; a packet data unit session or data radio bearer-based data forwarding address between a fifth node and the fourth node; and a packet data unit session or data radio bearer-based data forwarding address between the fifth node and the third node. Here, the fifth node is a secondary node of the first node.

In some embodiments, the first message may further comprise notification information for releasing a resource of a candidate cell on the fourth node, and the notification information may comprise identifier information of a to-be-released candidate cell on the fourth node.

In some embodiments, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

In some embodiments, the access layer security information of the candidate cell on the first node may comprise at least one of: an identifier of the candidate cell on the first node, an LTM configuration identifier, a key of the candidate cell, and a next hop chaining counter.

In some embodiments, the first message may further comprise at least one of: a globally unique access and mobility management function (AMF) identifier; a user equipment next generation (NG) application protocol identifier assigned by an access and mobility management function (AMF) network element; and downlink or uplink tunnel information of each packet data unit session resource.

In some embodiments, the second message may further comprise: information for releasing a resource of a candidate cell on the first node.

In some embodiments, a third message is transmitted by the first node to the fifth node, the third message may comprise at least one of: information for requesting a direct forwarding path and information for requesting a data forwarding address, and the fifth node is the secondary node of the first node. A fourth message is transmitted by the fifth node to the first node, and the fourth message may comprise at least one of: second information related to the direct forwarding path and second address information related to the data forwarding address.

In some embodiments, the second information may comprise at least one of: information on whether there is a direct forwarding path between the fifth node and the fourth node; and information on whether there is a direct forwarding path between the fifth node and the third node.

In some embodiments, the second address information may comprise at least one of: the packet data unit session or data radio bearer-based data forwarding address between the fifth node and the fourth node, and the packet data unit session or data radio bearer-based data forwarding address between the fifth node and the third node.

In some embodiments, the third message may further comprise information related to access layer security information of a candidate cell on the fifth node. Here, the information related to the access layer security information of the candidate cell on the fifth node is determined according to security information related to the access layer security information of the candidate cell on the first node.

In some embodiments, the first message may be an LTM Configuration Update message and a Cell Switch Notification message, and the second message may be an LTM Configuration Update Acknowledge message. For specific implementations of the messages such as the first message, the second message, the third message and the fourth message or the information, reference may be made to the corresponding descriptions in the method shown in FIG. 5, and thus the details will not be repeatedly described here.

Optionally, the second node may perform any of the operations performed by the GNB1/MN1 in the methods shown in FIGS. 3, 4A, and 4B, and accordingly, reference may be respectively made to the related descriptions of the operations in the above embodiments, and thus the details will not be repeatedly described here.

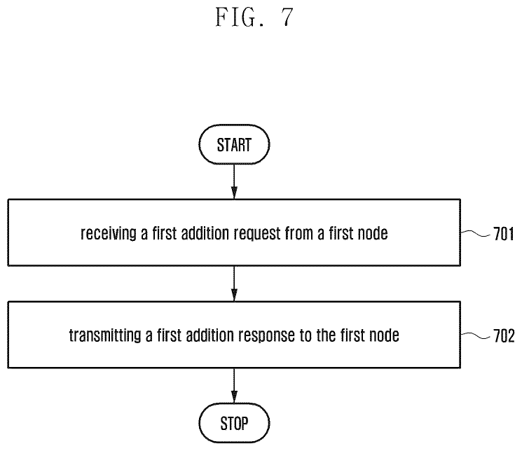

FIG. 7 illustrates a method performed by a third node in a wireless communication system according to an embodiment of the disclosure. For example, the method is suitable for being performed by the SN2 described in FIGS. 3, 4A, and 4B. According to the embodiment, the method performed by the third node in the wireless communication system comprises the following operations:

In operation 701, receiving a first addition request from a first node, the first addition request comprising a request used to request an addition of the third node as a secondary node to establish dual connectivity for the user equipment.

In operation 702, transmitting a first addition response to the first node, the first addition response comprising information related to an acknowledgement of the third node as the secondary node to establish the dual connectivity for the user equipment.

For a specific implementation of operation 701, reference may be made to operation 306, and for a specific implementation of the first addition request, reference may be made to the specific implementation of the SN Addition Request message in operation 306.

For a specific implementation of operation 702, reference may be made to operation 307, and for a specific implementation of the first addition response, reference may be made to the specific implementation of the SN Addition Request Acknowledge message in operation 307.

A second handover request is transmitted by a second node, a second handover response is transmitted by a fourth node, and the second handover response comprises context reference information of a user equipment at the third node. Here, the first node is a candidate node of the second node, and the third node is a secondary node of the fourth node. The context reference information of the user equipment at the third node comprises an identifier of the third node and an identifier assigned by the third node to the user equipment.

In some embodiments, the first addition request may further comprise first identifier information of the user equipment. The method may further comprise: determining resource configuration information of the user equipment at a candidate cell on the third node according to the first identifier information and a first rule. The first rule may comprise: configuring identical resources for the same user equipment at the same candidate cell. The first addition response may further comprise the resource configuration information of the user equipment at the candidate cell on the third node. For a specific implementation, reference may be made to the specific implementation of the establishment of the same set of candidate cell resources for the same UE in the method (e.g., operation 307) shown in FIG. 3.

For example, the first identifier information may be used to identify the user equipment, and the third node may identify, according to the first identifier information, which UE the first addition request as an SN addition request is for, and establish the same set of candidate cell resources for the same UE according to the first identifier information and the first rule.

In some embodiments, the method may further comprise: receiving a second addition request from the fourth node, the second addition request being used to request an addition of the third node as a secondary node to establish dual connectivity for the user equipment; and transmitting a second addition response to the fourth node. The second addition response may comprise information related to an acknowledgement of the third node as the secondary node to establish the dual connectivity for the user equipment.

In some embodiments, the second addition request may further comprise second identifier information of the user equipment. The second identifier information may comprise at least one of: an identifier of the second node and an identifier assigned by the second node to the user equipment. The second addition response may further comprise the resource configuration information of the user equipment at the candidate cell on the third node.

For a specific implementation of the reception of the second addition request from the fourth node, reference may be made to operation 302. For a specific implementation of the second addition request, reference may be made to the specific implementation of the SN Addition Request message in operation 302. For the second identifier information of the user equipment, reference may be made to the identifier of the user equipment in the above SN Addition Request Message. For a specific implementation of the transmitting of the second addition response to the fourth node, reference may be made to operation 303, and for a specific implementation of the second addition response, reference may be made to the specific implementation of the SN Addition Request Acknowledge message in operation 303.

In some embodiments, the first addition request may further comprise the first identifier information of the user equipment. The method may further comprise: determining the resource configuration information of the user equipment at the candidate cell on the third node according to the first identifier information and the first rule. The first rule may comprise: configuring identical resources for the same user equipment at the same candidate cell. The first addition response may further comprise the resource configuration information of the user equipment at the candidate cell on the third node.

In some embodiments, the user equipment switches from accessing to the second node to accessing to the fourth node. A first message is transmitted by the fourth node to the first node, and the first message may comprise at least one of: information for requesting a direct forwarding path, information for requesting a data forwarding address, and an identifier assigned by the second node to the user equipment. A second message is transmitted by the first node to the fourth node, and the second message may comprise at least one of: first information related to the direct forwarding path, first address information related to the data forwarding address, and an identifier assigned by the first node to the user equipment.

In some embodiments, the information for requesting the direct forwarding path may comprise at least one of: an identifier of the fourth node and the identifier of the third node.

In some embodiments, the first information may comprise information on whether there is a direct forwarding path between the first node and the third node based on a packet data unit session.

In some embodiments, the first address information may comprise at least one of: a packet data unit session or data radio bearer-based data forwarding address between the first node and the third node; a packet data unit session or data radio bearer-based data forwarding address between a fifth node and the fourth node; and a packet data unit session or data radio bearer-based data forwarding address between the fifth node and the third node. Here, the fifth node is a secondary node of the first node.

In some embodiments, the first message may further comprise notification information for releasing a resource of a candidate cell on the fourth node, and the notification information may comprise identifier information of a to-be-released candidate cell on the fourth node.

In some embodiments, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

In some embodiments, the access layer security information of the candidate cell on the first node may comprise at least one of: an identifier of the candidate cell on the first node, an LTM configuration identifier, a key of the candidate cell, and a next hop chaining counter.

In some embodiments, the first message may further comprise at least one of: a globally unique access and mobility management function (AMF) identifier; a user equipment next generation (NG) application protocol identifier assigned by an access and mobility management function (AMF) network element; and downlink or uplink tunnel information of each packet data unit session resource.

In some embodiments, the second message may further comprise information for releasing a resource of a candidate cell on the first node.

In some embodiments, a third message is transmitted by the first node to the fifth node, the third message may comprise at least one of: information for requesting a direct forwarding path and information for requesting a data forwarding address, and the fifth node is the secondary node of the first node. A fourth message is transmitted by the fifth node to the first node, and the fourth message may comprise at least one of: second information related to the direct forwarding path and second address information related to the data forwarding address.

In some embodiments, the second information may comprise at least one of: information on whether there is a direct forwarding path between the fifth node and the fourth node; and information on whether there is a direct forwarding path between the fifth node and the third node.

In some embodiments, the second address information may comprise at least one of: the packet data unit session or data radio bearer-based data forwarding address between the fifth node and the fourth node, and the packet data unit session or data radio bearer-based data forwarding address between the fifth node and the third node.

In some embodiments, the third message may further comprise information related to access layer security information of a candidate cell on the fifth node. Here, the information related to the access layer security information of the candidate cell on the fifth node is determined according to security information related to the access layer security information of the candidate cell on the first node.

In some embodiments, the first message may be an LTM Configuration Update message and a Cell Switch Notification message, and the second message may be an LTM Configuration Update Acknowledge message.

Optionally, the third node may perform any of the operations performed by the SN2 in the methods shown in FIGS. 3, 4A, and 4B, and accordingly, reference may be respectively made to the related descriptions of the operations in the above embodiments, and thus the details will not be repeatedly described here.

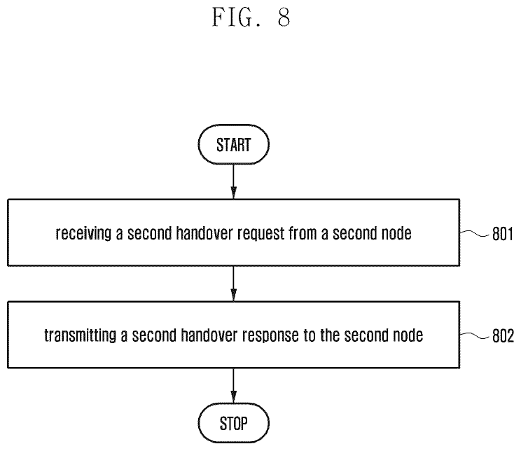

FIG. 8 illustrates a method performed by a fourth node in a wireless communication system according to an embodiment of the disclosure. The method is suitable for being performed by the GNB2/MN2 described in FIGS. 3, 4A, and 4B. According to the embodiment, the method performed by the fourth node in the wireless communication system comprises the following operations:

In operation 801, receiving a second handover request from a second node.

Optionally, for a specific implementation of the reception of the second handover request from the second node, reference may be made to the specific implementation of operation 301. For an implementation of the second handover request, reference may be made to the implementation of the first request message in operation 301.

In operation 802, transmitting a second handover response to the second node, the second handover response comprising context reference information of a user equipment at a third node.

The context reference information of the user equipment at the third node comprises an identifier of the third node and an identifier assigned by the third node to the user equipment, and the third node is a secondary node of the fourth node. A first handover request is transmitted by the second node to a first node, the first handover request comprises the context reference information of the user equipment at the third node, and the first node is a candidate node of the second node.

For a specific implementation of operation 802, reference may be made to operation 304, and for an implementation of the second handover response, reference may be made to the implementation of the first acknowledge message in operation 304.

In some embodiments, the method may further comprise: transmitting a second addition request to the third node, the second addition request being used to request an addition of the third node as a secondary node to establish dual connectivity for the user equipment; and receiving a second addition response from the third node, the second addition response comprising information related to an acknowledgement of the third node as the secondary node to establish the dual connectivity for the user equipment.

For a specific implementation of the transmitting of the second addition request to the third node, reference may be made to operation 302, and for a specific implementation of the second addition request, reference may be made to the specific implementation of the SN Addition Request message in operation 302.

For a specific implementation of the reception of the second addition response from the third node, reference may be made to operation 303. For a specific implementation of the second addition response, reference may be made to the specific implementation of the SN Addition Request Acknowledge message in operation 303.

In some embodiments, the second addition request may comprise second identifier information of the user equipment. The second identifier information may comprise at least one of: an identifier of the second node and an identifier assigned by the second node to the user equipment. The second addition response may further comprise resource configuration information of the user equipment at a candidate cell on the third node. The second handover response may further comprise the resource configuration information of the user equipment at the candidate cell on the third node.

For example, for a specific implementation of the second identifier information of the user equipment, reference may be made to the specific implementation of the identifier of the user equipment in the SN Addition Request message in operation 306.

In some embodiments, the user equipment switches from accessing to the second node to accessing to the fourth node. The method may further comprise: transmitting a first message to the first node. The first message may comprise at least one of: information for requesting a direct forwarding path, information for requesting a data forwarding address, and the identifier assigned by the second node to the user equipment. The method may further comprise: receiving a second message from the first node. The second message may comprise at least one of: first information related to the direct forwarding path, first address information related to the data forwarding address, and an identifier assigned by the first node to the user equipment.

Optionally, for a specific implementation of the first message, reference may be made to the related description in the method shown in FIG. 5, and the first message may be an LTM Configuration Update message or a Cell Switch Notification message. The second message may be an LTM Configuration Update Acknowledge message. For a specific implementation of the first message, reference may be made to the description of the LTM Configuration Update message or the Cell Switch Notification message in FIGS. 4A and 4B, and for a specific implementation of the second message, reference may be made to the description of the LTM Configuration Update Acknowledge message in FIGS. 4A and 4B, and thus the details will not be repeatedly described here.

In some embodiments, the first addition request may comprise first identifier information of the user equipment. The method may further comprise: determining resource configuration information of the user equipment at a candidate cell on the third node according to the first identifier information and a first rule. The first rule may comprise: configuring identical resources for the same user equipment at the same candidate cell, and the first addition response may further comprise the resource configuration information of the user equipment at the candidate cell on the third node.

In some embodiments, the user equipment has the handover from the access to the second node to the access to the fourth node. The first message is transmitted by the fourth node to the first node, and the first message may comprise at least one of: the information for requesting the direct forwarding path, the information for requesting the data forwarding address, and the identifier assigned by the second node to the user equipment. The second message is transmitted by the first node to the fourth node, and the second message may comprise at least one of: the first information related to the direct forwarding path, the first address information related to the data forwarding address, and the identifier assigned by the first node to the user equipment.

In some embodiments, the information for requesting the direct forwarding path may comprise at least one of: an identifier of the fourth node and the identifier of the third node.

In some embodiments, the first information may comprise information on whether there is a direct forwarding path between the first node and the third node based on a packet data unit session.

In some embodiments, the first address information may comprise at least one of: a packet data unit session or data radio bearer-based data forwarding address between the first node and the third node; a packet data unit session or data radio bearer-based data forwarding address between a fifth node and the fourth node; and a packet data unit session or data radio bearer-based data forwarding address between the fifth node and the third node. Here, the fifth node is a secondary node of the first node.

In some embodiments, the first message may further comprise notification information for releasing a resource of a candidate cell on the fourth node, and the notification information may comprise identifier information of a to-be-released candidate cell on the fourth node.

In some embodiments, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

In some embodiments, the access layer security information of the candidate cell on the first node may comprise at least one of: an identifier of the candidate cell on the first node, an LTM configuration identifier, a key of the candidate cell, and a next hop chaining counter.

In some embodiments, the first message may further comprise at least one of: a globally unique access and mobility management function (AMF) identifier; a user equipment next generation (NG) application protocol identifier assigned by an access and mobility management function (AMF) network element; and downlink or uplink tunnel information of each packet data unit session resource.

In some embodiments, the second message may further comprise: information for releasing a resource of a candidate cell on the first node.

In some embodiments, a third message is transmitted by the first node to the fifth node, the third message may comprise at least one of: information for requesting a direct forwarding path and information for requesting a data forwarding address, and the fifth node is the secondary node of the first node. A fourth message is transmitted by the fifth node to the first node, and the fourth message may comprise at least one of: second information related to the direct forwarding path and second address information related to the data forwarding address.

In some embodiments, the second information may comprise at least one of: information on whether there is a direct forwarding path between the fifth node and the fourth node; and information on whether there is a direct forwarding path between the fifth node and the third node.

In some embodiments, the second address information may comprise at least one of: the packet data unit session or data radio bearer-based data forwarding address between the fifth node and the fourth node, and the packet data unit session or data radio bearer-based data forwarding address between the fifth node and the third node.

In some embodiments, the third message may further comprise information related to access layer security information of a candidate cell on the fifth node. Here, the information related to the access layer security information of the candidate cell on the fifth node is determined according to security information related to the access layer security information of the candidate cell on the first node.

In some embodiments, the first message may be the LTM Configuration Update message and the Cell Switch Notification message, and the second message may be the LTM Configuration Update Acknowledge message.

Optionally, the fourth node may perform any of the operations performed by the GNB2/MN2 in the methods shown in FIGS. 3, 4A and 4B, and accordingly, reference may be respectively made to the related descriptions of the operations in the above embodiments, and thus the details will not be repeatedly described here.

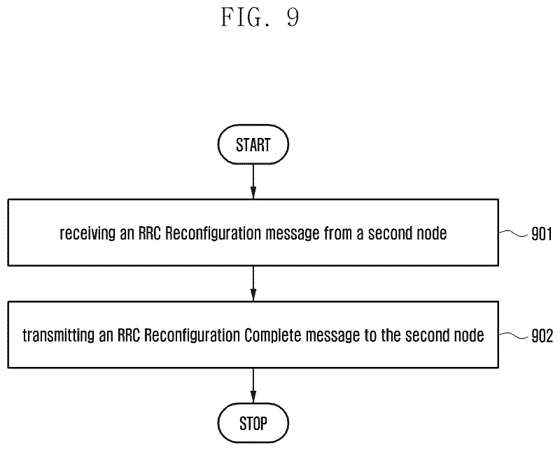

FIG. 9 illustrates a method performed by a user equipment in a wireless communication system according to an embodiment of the disclosure. According to the embodiment, the method performed by the user equipment in the wireless communication system comprises the following operations:

In operation 901, receiving an RRC Reconfiguration message from a second node, the RRC Reconfiguration message comprising cell configuration information of a fourth node and a third node.

In operation 902, transmitting an RRC Reconfiguration Complete message to the second node.

A second handover request is transmitted by the second node, a second handover response is transmitted by the fourth node, the second handover response comprises context reference information of the user equipment at the third node. Here, the context reference information of the user equipment at the third node comprises an identifier of the third node and an identifier assigned by the third node to the user equipment, and the third node is a secondary node of the fourth node. A first handover request is transmitted by the second node to a first node, the first handover request comprises the context reference information of the user equipment at the third node, and the first node is a candidate node of the second node.

As an example, for a specific implementation of the context reference information of the user equipment at the third node, reference may be made to the specific implementation of the context reference information of the UE at the candidate secondary node in the method shown in FIG. 3. For example, the identifier assigned by the third node to the user equipment may be a UE XnAP ID assigned by the third node to the UE.

In some embodiments, a first addition response may comprise first identifier information of the user equipment. The method may further comprise: determining resource configuration information of the user equipment at a candidate cell on the third node according to the first identifier information and a first rule. The first rule may comprise: configuring identical resources for the same user equipment at the same candidate cell. A first addition response may further comprise the resource configuration information of the user equipment at the candidate cell on the third node.

In some embodiments, the user equipment switches from accessing to the second node to accessing to the fourth node. A first message is transmitted by the fourth node to the first node, and the first message may comprise at least one of: information for requesting a direct forwarding path, information for requesting a data forwarding address, and an identifier assigned by the second node to the user equipment. A second message is transmitted by the first node to the fourth node, and the second message may comprise at least one of: first information related to the direct forwarding path, first address information related to the data forwarding address, and an identifier assigned by the first node to the user equipment.

In some embodiments, the information for requesting the direct forwarding path may comprise at least one of: an identifier of the fourth node and the identifier of the third node.

In some embodiments, the first information may comprise information on whether there is a direct forwarding path between the first node and the third node based on a packet data unit session.

In some embodiments, the first address information may comprise at least one of: a packet data unit session or data radio bearer-based data forwarding address between the first node and the third node; a packet data unit session or data radio bearer-based data forwarding address between a fifth node and the fourth node; and a packet data unit session or data radio bearer-based data forwarding address between the fifth node and the third node. Here, the fifth node is a secondary node of the first node.

In some embodiments, the first message may further comprise notification information for releasing a resource of a candidate cell on the fourth node, and the notification information may comprise identifier information of a to-be-released candidate cell on the fourth node.

In some embodiments, access layer security information of a candidate cell on the first node is received by the first node from the fourth node. Here, the access layer security information is received through a Layer 1 or Layer 2 Triggered Mobility (LTM) Configuration Update message, or received through a Cell Switch Notification message.

In some embodiments, the access layer security information of the candidate cell on the first node may comprise at least one of: an identifier of the candidate cell on the first node, an LTM configuration identifier, a key of the candidate cell, and a next hop chaining counter.

In some embodiments, the first message may further comprise at least one of: a globally unique access and mobility management function (AMF) identifier; a user equipment next generation (NG) application protocol identifier assigned by an access and mobility management function (AMF) network element; and downlink or uplink tunnel information of each packet data unit session resource.

In some embodiments, the second message may further comprise: information for releasing a resource of a candidate cell on the first node.

In some embodiments, a third message is transmitted by the first node to the fifth node, the third message may comprise at least one of: information for requesting a direct forwarding path and information for requesting a data forwarding address, and the fifth node is the secondary node of the first node. A fourth message is transmitted by the fifth node to the first node, and the fourth message may comprise at least one of: second information related to the direct forwarding path and second address information related to the data forwarding address.

In some embodiments, the second information may comprise at least one of: information on whether there is a direct forwarding path between the fifth node and the fourth node; and information on whether there is a direct forwarding path between the fifth node and the third node.

In some embodiments, the second address information may comprise at least one of: the packet data unit session or data radio bearer-based data forwarding address between the fifth node and the fourth node, and the packet data unit session or data radio bearer-based data forwarding address between the fifth node and the third node.

In some embodiments, the third message may further comprise information related to access layer security information of a candidate cell on the fifth node. Here, the information related to the access layer security information of the candidate cell on the fifth node is determined according to security information related to the access layer security information of the candidate cell on the first node.

In some embodiments, the first message may be an LTM Configuration Update message and a Cell Switch Notification message, and the second message may be an LTM Configuration Update Acknowledge message.

The technical features related to one or more of the node name, the base station name, the message name, the information name, etc. in the description of the disclosure may alternatively be replaced by names, and the changes in names all fall within the scope of the disclosure.

The above is a description of the methods performed by the nodes according to the embodiments of the disclosure. It should be understood that the corresponding operations shown in FIGS. 3, 4A, 4B, and 5 to 9 and the information contained in the operations are also within the scope of the disclosure. At the same time, the nodes performing the corresponding methods are also within the scope of the disclosure.

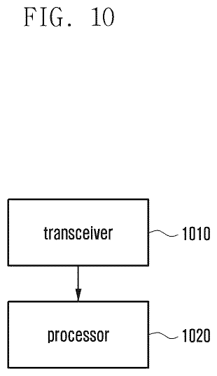

FIG. 10 illustrates a structure of each node applicable according to an embodiment of the disclosure. The node shown in FIG. 10 includes a transceiver 1010 and a processor 1020 coupled to the transceiver 1010. The transceiver 1010 is configured to transmit and receive a signal. The processor 1020 is configured to perform the method described in the disclosure. The disclosure may alternatively be implemented as a computer storage medium. The computer storage medium stores a computer executable instruction. When the stored computer executable instruction is executed by the processor, the processor performs the method described in the disclosure.

The various illustrative logical blocks, modules, and circuits described in the disclosure may be implemented or performed with a general purpose processor, a digital signal processor (DSP), an application specific integrated circuit (ASIC), a field programmable gate array (FPGA) or other programmable logic devices, a discrete gate or transistor logic, a discrete hardware component, or any combination thereof designed to perform the functions described herein. The general purpose processor may be a microprocessor, but in an alternative scheme, the processor may be any conventional processor, controller, microcontroller, or state machine. The processor may alternatively be implemented as a combination of computing devices, for example, a combination of a DSP and a microprocessor, a plurality of microprocessors, one or more microprocessors in collaboration with a DSP core, or any other such configuration.

The steps of the method or algorithm described in the disclosure may be embodied directly in hardware, in a software module executed by the processor, or in a combination of the two. The software module may reside in a RAM memory, a flash memory, a ROM memory, an EPROM memory, an EEPROM memory, a register, a hard disk, a removable disk, or any other form of storage medium known in the art. A storage medium is coupled to the processor, to enable the processor to read information from/write information to the storage medium. In an alternative scheme, the storage medium may be integrated to the processor. The processor and the storage medium may reside in an ASIC. The ASIC may reside in a user terminal. In an alternative scheme, the processor and the storage medium may reside as discrete components in a user terminal.

In one or more designs, the functions described may be implemented in hardware, software, firmware, or any combination thereof. If implemented in the software, the functions may be stored on or transmitted over a computer readable medium as one or more instructions or codes. The computer readable medium includes both a computer storage medium and a communication medium, the communication medium including any medium that facilitates the transfer of a computer program from one place to another. The storage medium may be any available medium that can be accessed by a general purpose or special purpose computer.

Example methods and apparatuses are described in combination with the accompanying drawings in the description set forth herein, and do not represent all the examples that may be implemented or that are within the scope of the claims. The term “example” used herein means “serving as an example, instance, or illustration,” rather than “preferred” or “advantageous over other examples.” The detailed description includes specific details for the purpose of providing an understanding of the described techniques. These techniques, however, may be practiced without these specific details. In some cases, well-known structures and devices are shown in the form of a block diagram in order to avoid obscuring the concepts of the described examples.

This specification contains many specific implementation details, but the implementation details should not be construed as a limitation to the scope of any disclosure or the scope claimed, but rather as a description for specific features in a specific embodiment of the specific disclosure. Certain features described in the context of separate embodiments in this specification may alternatively be implemented in combination in a single embodiment. Rather, the various features described in the context of a single embodiment may be implemented separately in a plurality of embodiments or implemented in any suitable sub-combination. Furthermore, the features may be described as functioning in certain combinations in the context, and even initially so claimed, but in some cases one or more features in a claimed combination may be deleted from the combination, and the claimed combination may be directed to a sub-combination or the variation of the sub-combination.

It should be understood that the specific order or hierarchy of steps in the method in the disclosure is an illustration for a process. Based on design preferences, it may be understood that the specific order or hierarchy of the steps in the method may be rearranged to achieve the functions and effects disclosed in the disclosure. The accompanying method claims present the elements of various steps in example order, but are not intended to be limited to the specific order or hierarchy presented, unless specifically stated otherwise. Furthermore, although an element may be described or claimed in a singular form, the plural can also be expected unless the limitation to the singular is explicitly stated. Thus, the disclosure is not limited to the examples shown, and any apparatus for performing the functions described herein is included in the aspects of the disclosure.

It can be understood that “at least one” described in the disclosure includes any and/or all possible combinations of the listed items, the various embodiments described in the disclosure and the various examples in the embodiments may be varied and combined in any suitable form, and “/” described in the disclosure represents “and/or.”

While the disclosure has been shown and described with reference to various embodiments thereof, it will be understood by those skilled in the art that various changes in form and details may be made therein without departing from the spirit and scope of the disclosure as defined by the appended claims and their equivalents.

1.-20. (canceled)

21. A method performed by a first node in a wireless communication system, the method comprising:
receiving, from a third node, a handover request message; and
transmitting, to a second node, a secondary node (SN) addition request message including information for identifying a source master node (MN) and a user equipment (UE) associated with the handover request message,
wherein the information enables the second node to identify the UE as being associated with the hand over request message received from the third node.

22. The method of claim 21, wherein the information includes a source MN identifier (ID) for identifying the source MN and a source MN UE Xn application protocol (XnAP) ID for identifying the UE.

23. The method of claim 21, further comprising:
in case that the first node is a new source MN, transmitting, to the fourth node, a layer1/layer2 (L1/L2) triggered mobility (LTM) configuration update message including security information for a subsequent LTM.

24. The method of claim 23, wherein the security information includes at least one of UE security capability information, access layer (AS) security information, and a candidate cell identifier (ID) corresponding to a new radio (NR) cell global identifier (CGI).

25. The method of claim 24,
wherein the UE security capability information includes at least one of an new radio (NR) encryption algorithm and an NR integrity protection algorithm, and
wherein AS security information includes at least one of a key next generation radio access network (NG-RAN) star and a next hop chaining counter (NCC).

26. The method of claim 21, further comprising:
in case that the fourth node is a new source MN, receiving, from the fourth node, a layer 1/layer 2 (L1/L2) triggered mobility (LTM) configuration update message including security information for a subsequent LTM; and
transmitting, to a fifth node, a SN modification request message.

27. The method of claim 26, wherein the SN modification request message includes an SN security key.

28. A method performed by a second node in a wireless communication system, the method comprising:
receiving, from a first node, a secondary node (SN) addition request message including information for identifying a source master node (MN) and a user equipment (UE) associated with the handover request message; and
identifying, based on the information, the source MN and the UE,
wherein the information enables the second node to identify the UE as being associated with the handover request message received from a third node.

29. The method of claim 28, wherein the information includes a source MN identifier (ID) for identifying the source MN and a source MN UE Xn application protocol (XnAP) ID for identifying the UE.

30. The method of claim 28, further comprising:
receiving, from a candidate MN, an SN modification request message including an SN security key.

31. A first node in a wireless communication system, the first node comprising:
at least one transceiver;
at least one processor communicatively coupled to the at least one transceiver; and
at least one memory, communicatively coupled to the at least one processor, storing instructions executable by the at least one processor individually or in any combination to cause the first node to:
receive, from a third node, a handover request message, and
transmit, to a second node, a secondary node (SN) addition request message including information for identifying a source master node (MN) and user equipment (UE) associated with the handover request message,
wherein the information enables the second node to identify the UE as being associated with the hand over request message received from the third node.

32. The first node of claim 31, wherein the information includes a source MN identifier (ID) for identifying the source MN and a source MN UE Xn application protocol (XnAP) ID for identifying the UE.

33. The first node of claim 31, wherein the instructions executable by the at least one processor individually or in any combination further cause the first node to:
in case that the first node is a new source MN, transmit, to the fourth node, a layer1/layer2 (L1/L2) triggered mobility (LTM) configuration update message including security information for a subsequent LTM.

34. The first node of claim 33, wherein the security information includes at least one of UE security capability information, access layer (AS) security information, and a candidate cell identifier (ID) corresponding to a new radio (NR) cell global identifier (CGI).

35. The first node of claim 34,
wherein the UE security capability information includes at least one of an new radio (NR) encryption algorithm and an NR integrity protection algorithm, and
wherein AS security information includes at least one of a key next generation radio access network (NG-RAN) star and a next hop chaining counter (NCC).

36. The first node of claim 31, wherein the instructions executable by the at least one processor individually or in any combination further cause the first node to:
in case that the fourth node is a new source MN, receive, from the fourth node, a layer 1/layer 2 (L1/L2) triggered mobility (LTM) configuration update message including security information for a subsequent LTM, and
transmit, to a fifth node, a SN modification request message.

37. The first node of claim 36, wherein the SN modification request message includes an SN security key.

38. A second node in a wireless communication system, the second node comprising:
at least one transceiver;
at least one processor communicatively coupled to the at least one transceiver; and
at least one memory, communicatively coupled to the at least one processor, storing instructions executable by the at least one processor individually or in any combination to cause the second node to:
receive, from a first node, a secondary node (SN) addition request message including information for identifying a source master node (MN) and a user equipment (UE) associated with the handover request message, and
identify, based on the information, the source MN and the UE,
wherein the information enables the second node to identify the UE as being associated with the handover request message received from a third node.

39. The second node of claim 38, wherein the information includes a source MN identifier (ID) for identifying the source MN and a source MN UE Xn application protocol (XnAP) ID for identifying the UE.

40. The second node of claim 38, wherein the instructions executable by the at least one processor individually or in any combination further cause the second node to:
receive, from a candidate MN, an SN modification request message including an SN security key.
